(19) United States
(12) Patent Application Publication
(10) Pub. No.: US 2014/0249861 A1
(43) Pub. Date: Sep. 4, 2014

(54) Identification and Selection of Healthcare Claim Transactions for Requesting Increases in Reimbursement Levels

(71) Applicant: MCKESSON CORPORATION, San Francisco, CA (US)

(72) Inventors: David Gamble, Grove City, OH (US); Rudy Milosevich, Columbus, OH (US)

(73) Assignee: MCKESSON CORPORATION, San Francisco, CA (US)

(21) Appl. No.: 13/782,909

(22) Filed: Mar. 1, 2013

(51) Int. Cl. G06Q 40/08

(52) U.S. Cl. CPC G06Q 40/08
USPC 705/4

(57) ABSTRACT

Systems, methods and computer-readable media are disclosed for performing various filtering operations and selection processing on healthcare claim transaction data associated with a plurality of healthcare claim transactions. The filtering operations may include a first filtering operation to identify healthcare claim transactions reimbursed at a loss and a second filtering operation to further identify those transactions reimbursed at a MAC rate below cost. The selection processing may be performed to identify, from among the filtered healthcare claim transactions and based at least in part on one or more selection parameter thresholds, those transactions that are suitable candidates for MAC rate appropriateness review by a claims processor. Upon identification of the candidate healthcare claim transactions, one or more representative claim transactions may be selected therefrom, and information associated therewith may be communicated to an appropriate claims processor as part of a request for an increase in MAC rate(s) associated with healthcare product(s).

### FIELD OF THE DISCLOSURE

This disclosure relates generally to healthcare claim transactions, and more particularly, to identifying healthcare claim transactions reimbursed at a loss that are candidates for use in requesting review of associated reimbursement levels.

### BACKGROUND

When an insured patient fills a prescription at a retail pharmacy for example, the pharmacy generates a healthcare claim transaction that is communicated to a claims processor system for adjudication, typically via one or more intermediate service provider systems. The pharmacy is typically reimbursed for the healthcare claim transaction at an amount set by the public or private insurance entity under which the patient is insured or by a Pharmacy Benefit Manager (PBM) administering the insured patient's drug plan on behalf of the public or private insurance entity. PBMs typically designate a threshold value referred to as the Maximum Allowable Cost or Maximum Allowable Charge (MAC) that represents an upper limit at which a healthcare claim transaction for a particular healthcare product or service will be reimbursed.

### BRIEF DESCRIPTION OF THE DRAWINGS

The detailed description is set forth through reference to the accompanying drawings. In the drawings, the left-most digit(s) of a reference numeral identifies the drawing in which the reference numeral first appears. The use of the same reference numerals indicates similar or identical items; however, similar or identical items may also be designated with different reference numerals. Various embodiments may utilize elements and/or components other than those illustrated in the drawings, and some elements and/or components may not be present in various embodiments. A description of a component or element in the singular may, depending on the context, encompass a plural number of such components or elements and vice versa.

FIG. 1 depicts an illustrative system architecture for identifying healthcare claim transactions reimbursed below cost and performing various filtering and selection processing to further identify those healthcare claim transactions reimbursed below cost that are candidates for requesting or negotiating increases in reimbursement amounts in accordance with one or more embodiments of the disclosure.

FIG. 2 is a process flow diagram of an illustrative method for performing various filtering and selection processing on healthcare claim transaction data in order to identify one or more representative healthcare claim transactions for use in requesting or negotiating increases in reimbursement amounts in accordance with one or more embodiments of the disclosure.

FIG. 3 is a process flow diagram of an illustrative method for identifying healthcare claim transactions reimbursed at a MAC rate below cost in accordance with one or more embodiments of the disclosure.

FIG. 4 is a process flow diagram of an illustrative method for identifying subgroups of healthcare transactions reimbursed at a MAC rate below cost that are candidates for use in requesting or negotiating increases in reimbursement amounts in accordance with one or more embodiments of the disclosure.

FIG. 5 is a process flow diagram of an illustrative method for selecting representative healthcare transactions among candidate healthcare transactions, communicating information associated with the selected representative healthcare transactions to a claims processor, and receiving one or more response messages thereto in accordance with one or more embodiments of the disclosure.

### DETAILED DESCRIPTION OF EMBODIMENTS OF THE DISCLOSURE

### Overview

Embodiments of the disclosure relate to, among other things, systems, methods, computer-readable media, techniques and methodologies for analyzing healthcare claim transaction data to identify healthcare claim transactions associated with healthcare products that have been reimbursed below a cost associated with the healthcare products and performing various filtering and selection processing with respect to such healthcare claim transactions to identify those transactions that are suitable candidates for use in negotiating or requesting increases in reimbursement amounts.

Typically, when an insured patient fills a prescription for a healthcare product at a pharmacy or other healthcare provider location, a healthcare claim transaction is generated by the healthcare provider system and transmitted to a claims processor system for adjudication. The healthcare claim transaction may be routed from the healthcare provider system to the claims processor system via one or more intermediary entities such as a service provider system. The service provider system may support functionality for receiving the healthcare transaction, performing any edits, modifications or determinations with respect to information included in the healthcare claim transaction (which may potentially involve further communication between the service provider system and the healthcare provider system), and routing the healthcare transaction to the appropriate claims processor system.

It should be noted that while embodiments of the disclosure may be described in the context of a healthcare provider that is a pharmacy, it should be appreciated that the healthcare provider may be any suitable healthcare provider including, but not limited to, a pharmacy, a prescriber, another drug distributor or drug dispensing entity, and so forth. The claims processor associated with the claims processor system may be a public or private insurance entity offering an insurance product or plan under which the patient is insured or an entity operating on behalf of such a public or private insurance entity such as a Pharmacy Benefits Manager (PBM). While certain embodiments of the disclosure may be described in the context of a claims processor that is a PBM, it should be appreciated that the claims processor may be any suitable entity that adjudicates healthcare transactions including, but not limited to, any private payor, any public payor such as a government payor, a claims clearinghouse, and so forth. In addition, the healthcare product may be any suitable product or service for which reimbursement may be sought by a healthcare provider from a claims processor or other insuring entity. For example, the healthcare product may be a branded or generic prescription product, a non-prescription product, a healthcare service, and so forth.

Upon receipt of the healthcare claim transaction, the claims processor system adjudicates the transaction to determine the patient's eligibility for reimbursement, and if determined to be eligible, the reimbursement amount that will be paid to the dispensing healthcare provider. The claims processor system generates an adjudication response including information identifying the results of the adjudication processing and communicates the response to the healthcare provider system, potentially via the service provider system. In various implementations, the healthcare claim transaction generated by the healthcare provider system and received by the claims processor system may take the form of an adjudication request data segment and, upon adjudication, the eligibility determination and reimbursement amount (if any) may be appended to the adjudication request data segment to generate an adjudication response data segment. An adjudication data packet including both the adjudication request data segment and the adjudication response data segment may then be communicated by the claims processor system to the healthcare provider system.

The reimbursement amount determined for a healthcare product may be influenced by any number of factors including whether a contracted rate between the healthcare provider and the PBM exists for the healthcare product, the “Usual and Customary” amount or the “Ingredient Cost Submitted” amount identified by the healthcare provider for the dispensed healthcare product, the MAC amount identified by the PBM for the healthcare product, and so forth. The “Usual and Customary” amount may represent a cash price that a drug dispenser such as a pharmacy would accept for a particular healthcare product. The “Ingredient Cost Submitted” amount may represent a sum of the acquisition cost of the healthcare product to the healthcare provider and a predetermined markup.

Upon adjudication of associated healthcare claim transactions, various healthcare products may be consistently reimbursed at a level that is below the acquisition cost of the healthcare product to the healthcare provider. This is a significant issue for a healthcare provider as dispensing of certain healthcare products may result in significant loss if reimbursement levels are substantially less than the acquisition costs associated with such healthcare products. While the MAC rate represents an upper threshold for reimbursement, claims processors generally reimburse healthcare claim transactions at an amount that is the least of a variety of different potential reimbursement amounts. Accordingly, certain healthcare claim transactions may be reimbursed at a level that is below acquisition cost because such transactions were reimbursed at a “Usual and Customary” rate, a contracted rate, or an “Ingredient Cost Submitted” rate that was less than the MAC rate. However, for certain healthcare claim transactions, the MAC rate may represent the least of these various rates, and reimbursement at a MAC rate that is less than the acquisition cost of the healthcare product to the healthcare provider may result in a loss to the healthcare provider. The MAC rate is generally not tied to an industry benchmark and is typically set independently by a PBM. Accordingly, scenarios may repeatedly arise in which healthcare claim transactions are reimbursed at a MAC rate that results in a loss to the healthcare provider.

This disclosure describes systems, methods, computer-readable media, techniques and methodologies for filtering healthcare claim transaction data to identify healthcare claim transactions associated with healthcare products reimbursed at MAC rates that are below the acquisition costs of such products, performing various selection processing to identify, based on one or more selection parameters and associated thresholds, those healthcare transactions reimbursed at a MAC rate below cost that are suitable candidates for use in negotiating or requesting an increase in MAC rates, and ultimately selecting one or more representative healthcare transactions from the candidate healthcare transactions as a basis for requesting an increase in MAC rates.

According to embodiments of the disclosure, a reimbursement analysis system including one or more reimbursement analysis computers may be provided. The reimbursement analysis system may receive healthcare claim transaction data from a variety of sources. For example, healthcare claim transaction data may be received from a service provider system that supports functionality for routing healthcare transactions between healthcare providers and claims processors. The reimbursement analysis system may also receive healthcare claim transaction data from healthcare provider systems associated with various healthcare providers.

The healthcare claim transaction data may represent data relating to adjudicated healthcare claim transactions associated with healthcare products that have been dispensed to a patient. More specifically, the claim transaction data may relate to healthcare claim transactions that have been generated by healthcare provider systems and communicated to appropriate claims processor systems for adjudication, and for which adjudication responses indicating reimbursement amounts or levels have been received. For example, healthcare claim transaction data relating to adjudicated healthcare claim transactions may be harvested across a variety of healthcare providers and transmitted to the reimbursement analysis system. In certain embodiments, the healthcare claim transaction data may be received as one or more data files according to any suitable file format. However, embodiments of the disclosure are not so limited and the healthcare claim transaction data may be received in any suitable form or format.

The reimbursement analysis system may be connected to various healthcare provider and service provider systems via one or more networks and may receive the healthcare claim transaction data as part of a data stream on a batch or real-time basis. Alternatively, or additionally, the healthcare provider system(s) and/or service provider system(s) may store the healthcare claim transaction in one or more shared datastores that are accessible by the reimbursement analysis system. It should be appreciated that embodiments of the disclosure are not limited to any particular mechanism for receipt of the healthcare claim transaction data by the reimbursement analysis system.

The reimbursement analysis system may also receive price data from one or more data sources. The price data may include data relating to a respective acquisition price or cost associated with each of a variety of healthcare products. The respective acquisition cost identified for each healthcare product may, in certain embodiments, represent an average acquisition cost. An average acquisition cost may be used to account for variation between geographic regions and healthcare providers (e.g., pharmacies). In various embodiments, the acquisition cost identified for a particular healthcare product may not take into account any rebates that may be associated with that product. However, as described in more detail later in this disclosure, rebates on healthcare products may be taken in account in determining which healthcare transactions may be suitable candidates for requesting an increase in MAC rates. As with the healthcare claim transaction data, the price data may be similarly received on a batch or real-time basis and may be received from any suitable data source including, but not limited to, service provider systems, healthcare provider systems, systems hosted or managed by other third parties, and so forth.

Upon receipt of the healthcare claim transaction data, the reimbursement analysis system may perform various optional processing on the data (e.g., parse the data) and store the processed data in one or more datastores. Similarly, upon receipt of the price data, the reimbursement analysis system may perform various optional processing on the data and store the processed price data in one or more datastores. In certain embodiments, the healthcare claim transaction data and the price data may be stored in separate datastores, while in other embodiments one or more shared datastores may store at least a portion of the healthcare claim transaction data and at least a portion of the price data.

Upon receipt and storage of the healthcare claim transaction data and the price data, the reimbursement analysis system may perform, invoke, or otherwise facilitate a first filtering operation to identify a first group of healthcare claim transactions from the healthcare claim transaction data that were reimbursed at a reimbursement level that was less than the acquisition cost associated with the healthcare product. More specifically, the first filtering operation may analyze the healthcare claim transaction data using the price data to identify, on a per-claim basis, those healthcare claim transactions for which the reimbursement amount was less than the acquisition cost of the healthcare product, as specified in the price data. In certain embodiments, the first filtering operation may be performed responsive to input received from a user.

In various embodiments, the first group of healthcare claim transactions may include transactions that were reimbursed at levels below acquisition cost, but where the reimbursement level does not correspond to a MAC rate. For example, such healthcare transactions may have been reimbursed at a “Usual and Customary” rate, a contracted rate, or an “Ingredient Cost Submitted” rate that was below the MAC rate and—for any of a variety of reasons—below the acquisition costs of the associated healthcare products. Such healthcare claim transactions may not serve as appropriate candidates for negotiating or requesting an increase in a reimbursement level, or more specifically, an increase in the MAC rate, because such transactions did not result in a loss to a healthcare provider that resulted from a MAC rate that is below acquisition cost, and thus, may not be relevant to a review as to whether the MAC rate for a particular healthcare product has been appropriately set.

Accordingly, in various embodiments of the disclosure, a second filtering operation may be performed with respect to the first group of healthcare claim transactions to identify a second group of healthcare claim transactions reimbursed at the MAC rate and which resulted in a loss to the healthcare provider as a result of the MAC rate being less than the acquisition cost of the associated healthcare product. The second filtering operation may utilize various filtering criteria to exclude any healthcare claim transactions in the first group that were reimbursed at reimbursement levels corresponding to values other than the MAC rate. In certain embodiments, the second filtering operation may be performed responsive to user input.

In various embodiments, the filtering operations may reveal numerous healthcare products having associated healthcare claim transactions that were reimbursed at a MAC rate below acquisition cost. It may not be practical to provide a claims processor with representative healthcare claim transactions associated with each such product in order to request MAC rate increases as this may inundate the claims processor with requests and delay the processing of such requests. Rather, in various embodiments, it may more expedient to identify those healthcare products associated with below cost MAC rate reimbursements that are the strongest potential candidates for obtaining a MAC rate increase. Accordingly, upon performing, invoking, or otherwise facilitating the second filtering operation, the reimbursement analysis system may perform or otherwise facilitate selection processing in order to identify those healthcare claim transactions deemed to be appropriate candidates for negotiating or requesting an increase in a respective MAC rate associated with each of one or more healthcare products. As part of the selection processing, selection parameters associated with healthcare products may be compared to associated selection parameter thresholds in order to identify those healthcare products for which a MAC rate increase would be most appropriate or desired.

As a non-limiting example, the second group of healthcare claim transactions identified based on the second filtering operation may include healthcare claim transactions associated with multiple healthcare products. The selection processing may facilitate identification of those healthcare products for which the most compelling case for a MAC rate increase can be made. Various selection parameters may be used to identify suitable candidate healthcare claim transactions. The selection parameters may include, but are not limited to, a metric associated with net loss (e.g., an average net loss), a metric associated with margin loss (e.g., an average margin loss), a total number of healthcare claim transactions reimbursed below cost for a particular healthcare product, and so forth.

The selection parameter(s) may be compared to associated selection parameter threshold(s) in order to determine those healthcare product(s) for which the threshold is met, thereby making healthcare claim transactions associated with those product(s) suitable candidates for use in requesting an increase in the MAC rate. The selection parameter thresholds may include, but are not limited to, a threshold percentage of the acquisition cost of a healthcare product, a threshold difference between the acquisition cost and the reimbursement level, a threshold number of healthcare transactions reimbursed below cost, and so forth.

In certain embodiments, the particular selection parameter used for making an assessment with respect to the candidacy of a particular healthcare product may be based, at least in part, on one or more characteristics associated with the healthcare product. For example, in the case of a generic product, a metric associated with margin loss may provide a better indication of a discrepancy between the MAC rate and the acquisition cost of the generic product as compared to a metric associated with net loss. For example, the actual dollar loss associated with reimbursement of a generic product at a MAC rate below acquisition cost may not be significant. However, the margin loss may represent a significant percentage of the acquisition cost of the generic product, in which case, the healthcare claim transactions associated with that generic healthcare product may, in fact, be suitable candidates for use in requesting an increase in a MAC rate for that product.

Along similar lines, in the case of a branded product having an acquisition cost that is significantly higher than that of a generic product, a metric associated with net loss may provide a better indication of a discrepancy between the MAC rate and the acquisition cost of the branded product as compared to a metric associated with margin loss. For example, while the margin loss associated with reimbursement of a branded product at a MAC rate below acquisition cost may not be significant, the net loss may be substantial, in which case, healthcare claim transactions associated with that branded product may, in fact, be suitable candidates for use in requesting an increase in the MAC rate for that product.

In yet other embodiments, the total number of healthcare claim transactions reimbursed at a MAC rate below acquisition cost may be an appropriate selection parameter for consideration. For example, there may exist scenarios in which neither the margin loss nor the net loss is significant for each healthcare claim transaction associated with a particular healthcare product; however, the sheer number of such healthcare claim transactions may justify requesting a MAC rate increase for that healthcare product. It should be appreciated that the above examples are merely illustrative and that numerous other selection parameters and criteria for choosing selection parameters are within the scope of this disclosure.

Upon identification of one or more healthcare products associated with healthcare claim transactions having MAC rate reimbursement levels that satisfy associated selection parameter thresholds, further selection processing may be performed to identify, based at least in part on one or more selection criteria, one or more representative healthcare claim transactions for submission to an appropriate claims processor as part of a request for a MAC rate increase. The selection criteria may include any suitable criterion including, but not limited to, a largest net loss, a largest margin loss, and so forth. In certain embodiments, one or more representative healthcare claim transactions may be selected for each healthcare product identified as a candidate for requesting an increase in the MAC rate. For example, a representative healthcare claim transaction associated with the largest margin loss or the largest net loss may be chosen for each candidate healthcare product. When considering a particular healthcare product, a particular associated healthcare claim transaction may be representative of both the largest margin loss and the largest net loss. In certain other embodiments, a representative healthcare claim transaction may not be selected for each candidate healthcare product. For example, in certain embodiments, a healthcare claim transaction associated with the largest margin loss or the largest net loss across all candidate healthcare products or some subset of candidate healthcare products may be selected for use in requesting an increase in MAC rates.

In certain embodiments, the reimbursement analysis system may include a reimbursement analysis application that facilitates the filtering processing and/or the selection processing. For example, a user interface associated with the reimbursement analysis application may be presented to a user via which the user may provide input instructing the application to perform various filtering and/or selection operations. As a non-limiting example, in certain embodiments, a user may provide input to the reimbursement analysis application instructing the application to display information associated with all healthcare claim transactions associated with a designated claims processor such as a particular PBM. The displayed healthcare claim transactions may include all transactions associated with the selected PBM for which healthcare claim transaction data is available including both transactions reimbursed below cost as well as transactions that were profitable (e.g., where the reimbursement amount exceeded the acquisition cost of the healthcare product).

The user may then provide input to the reimbursement analysis application instructing the application to perform the first filtering operation to filter out those healthcare claim transactions that were profitable so as to yield a first group of healthcare claim transactions including only those transactions that were reimbursed below cost. Responsive to additional user input, the reimbursement analysis application may perform the second filtering operation on the first group of healthcare transactions in order to identify and filter out those healthcare claim transactions that were reimbursed at a rate below the MAC rate for the associated healthcare products such as at a “Usual and Customary” rate, a contracted rate, an “Ingredient Cost Submitted” rate, and so forth. As previously noted, such healthcare claim transactions may not be appropriate candidates for requesting an increase in a MAC rate. Thus, the second filtering operation may identify a second group of healthcare claim transactions corresponding to the first group of healthcare claim transactions but excluding those healthcare claim transactions that were reimbursed at rates less than the MAC rate. While the first and second filtering operations have been described as being performed by the reimbursement analysis application responsive to user input, it should be appreciated that in certain embodiments the first and second filtering operations may be performed by a scheduled software process that may be performed independently of the reimbursement application and independently of user input.

Upon filtering the healthcare claim transaction data in accordance with the first and second filtering operations, various selection processing may be performed on the second group of healthcare claim transactions to identify those healthcare products that are suitable candidates for requesting an increase in associated MAC rates. The selection processing may utilize various respective selection parameters and associated selection thresholds associated with each healthcare product in order to identify those healthcare product(s) that are suitable candidates for requesting MAC rate increases. In certain embodiments, the selection parameters and associated thresholds may be user-configurable while in other embodiments one or more of the selection parameters and associated threshold(s) may be predetermined. The selection parameters and associated thresholds may be specified dynamically at the time that selection processing is initiated or may be pre-specified.

The reimbursement analysis application may, responsive to user input, perform selection processing to identify those healthcare claim transactions from the filtered healthcare transaction that satisfy associated selection parameter thresholds. As used herein, the term “filtered healthcare transaction” may refer to a healthcare claim transaction reimbursed at a MAC rate below acquisition cost (e.g., a healthcare claim transaction that is part of the second group of healthcare claim transactions). As a non-limiting example, all filtered healthcare claim transactions for which the margin loss resulting from reimbursement at a MAC rate below acquisition cost met or exceeded a threshold margin loss may be identified. As another non-limiting example, all filtered healthcare claim transactions for which a net loss resulting from reimbursement at a MAC rate below acquisition cost met or exceeded a threshold net loss may be identified. In certain embodiments, the determination as to whether a particular selection parameter threshold has been met may be made on a per-claim basis. For example, each filtered healthcare claim transaction may be analyzed to determine whether a selection parameter associated with the healthcare claim transaction (e.g., a margin loss, a net loss, etc.) exceeds an associated threshold.

In other embodiments, the selection processing may analyze the aggregate of filtered healthcare claim transactions associated with a healthcare product. For example, the average margin loss or average net loss associated with all filtered healthcare transactions corresponding to a particular healthcare product may be compared to an associated threshold such as a margin loss threshold (e.g., a threshold percentage of the acquisition cost of the healthcare product) or a net loss threshold (e.g., a threshold difference between the MAC rate reimbursement level and the acquisition cost of the healthcare product) to identify those healthcare products that are suitable candidates for requesting an increase in associated MAC rates. As yet another non-limiting example of analysis with respect to an aggregate of filtered healthcare claim transactions, the total number of filtered healthcare claim transactions associated with a particular healthcare product may be analyzed to determine whether the number of transactions meets or exceeds an associated threshold number of transactions, and if so, that healthcare product may be identified as a candidate for requesting an increase in the MAC rate.

In various embodiments, the particular selection parameter and associated selection parameter threshold chosen for analysis of a healthcare claim transaction, whether on a per-claim basis or on an aggregate basis, may be determined or identified based at least in part on one or more characteristics associated with the healthcare product to which the healthcare claim transaction relates. For example, if the healthcare product is a generic product, then the selection parameter used for analysis may be a margin loss or average margin loss. In contrast, if the healthcare product is a branded product, then the selection parameter used for analysis may be a net loss or average net loss. It should be appreciated that the above examples of selection parameters, selection parameter thresholds, and selection processing mechanisms utilizing the selection parameters and associated thresholds are merely illustrative and that other parameters, parameter thresholds, and associated selection processing mechanisms are within the scope of this disclosure.

In various embodiments, as a result of the selection processing described above, a third group of healthcare claim transactions may be identified from the second group of healthcare transactions described earlier. The third group of healthcare claim transactions may include each healthcare claim transaction associated with a healthcare product determined to be a suitable candidate for requesting a MAC rate increase (based for example on the aggregate selection processing described above). Alternatively, the third group of healthcare claim transactions may include each healthcare claim transaction for which a corresponding selection parameter is determined to meet or exceed an associated selection parameter threshold (based for example on the per-claim selection processing described earlier).

In various embodiments, the reimbursement analysis application may provide an indication of the candidate healthcare claim transactions identified as a result of the selection processing. The indication may be, for example, a graphical, textual, or other visual indication of the candidate healthcare transactions that may be presented to the user via a user interface of the reimbursement analysis application. In certain embodiments, the user of the application may proceed to select one or more representative healthcare claim transactions from the candidate healthcare claim transactions to present to a claims processor for requesting a MAC rate increase. The selection of representative healthcare claim transaction(s) may be manual or may be an automated process based on one or more selection criteria. As a non-limiting example, the selection criteria may include, but is not limited to, a largest net loss, a largest margin loss, and so forth. Those healthcare claim transactions satisfying the selection criteria may be selected among the candidate healthcare claim transactions for each healthcare product. Accordingly, in such a scenario, a representative healthcare claim transaction may be chosen for each healthcare product associated with at least one candidate healthcare claim transaction. In other embodiments, a representative healthcare claim transaction may not be chosen for certain healthcare products even if candidate healthcare claim transaction(s) are associated with the healthcare product in order to avoid potentially inundating the claims processor with MAC rate increases or to avoid distracting from those healthcare products for which low MAC rates are causing the most significant losses to healthcare providers.

Upon identification of representative healthcare transactions, the transactions may be imported into a database table, data file or otherwise aggregated for communication to an appropriate claims processor on a batch basis. The representative healthcare claim transactions and/or information associated therewith may be communicated to the claims processor as part of a request to review and increase associated MAC rates. It should be appreciated that the representative healthcare claim transactions and associated information may be communicated to the claims processor in any suitable manner. The claims processor may communicate one or more response messages responsive to receipt of the representative healthcare claim transactions and associated information. The response message(s) may indicate an amount of increase for each MAC rate that the claims processor agrees to increase. The response message(s) may further provide an indication of one or more reasons for not increasing any MAC rates that the claims processor determines not to increase. Various reasons may be provided in connection with a determination not to increase a MAC rate. For example, “MAC not raised due to utilization” may be provided as a reason for not increasing the MAC rate of a particular healthcare product. More specifically, the PBM (or other claims processor) may determine, based on the insured patient's plan, that another healthcare product, while not generically equivalent to the dispensed product (e.g., contains a different active ingredient), should have been dispensed in lieu of the product that was dispensed. In such a scenario, the response message associated with that healthcare product may indicate that the MAC rate was not raised “due to utilization.” In another non-limiting example, the claims processor may determine not to raise the MAC rate for a healthcare product because the claims processor believes the product is available for less on the market than the cost paid by the healthcare provider. For example, the claims processor may identify a wholesaler or other entity that is offering the healthcare product for less.

As yet another non-limiting example, the claims processor may indicate that a representative healthcare transaction was not considered for a MAC rate increase because the transaction was reversed by the healthcare provider, which may be the case if, for example, the patient did not pick up a filled prescription. In such scenarios, one or more additional representative healthcare claim transactions associated with the same healthcare product may be identified and communicated to the claims processor for requesting a MAC rate increase. Further, in certain embodiments, multiple representative healthcare claim transactions for a particular healthcare product may be proactively communicated to a claims processor in order to account for the possibility that one or more of the healthcare claim transactions are reversed. In addition, multiple representative healthcare claim transactions associated with a particular product may also be communicated to a claims processor in those situations in which the number of candidate healthcare claim transactions associated with that product meets or exceeds a threshold number of transactions in order to emphasize the urgency of the review of the adequacy of the MAC rate. Moreover, information indicating that the representative healthcare claim transactions are representative of a much larger number of transactions may also be communicated to the claims processor to emphasize the amount of loss that is being generated.

In various embodiments, upon receiving the response(s) from the claims processor, information relating to those MAC rate(s) that have been increased and/or information relating to those MAC rate(s) that have not been increased may be communicated to appropriate healthcare providers. The information may be communicated to the healthcare providers via a data stream or may be published for review by the healthcare providers. In certain embodiments, the response message(s) received from the claims processor may indicate that the MAC rate has been raised for a particular healthcare product but may not indicate the amount of the increase. In such embodiments, information indicating that the MAC rate for a particular product has been increased may be communicated to healthcare providers, but that the new MAC rate is not known. Healthcare providers may utilize this information to review future reimbursements to ensure that an increased MAC rate is being applied.

Embodiments of the disclosure provide numerous technical effects and advantages over conventional solutions. For example, the automation of the filtering and selection processing described herein significantly reduces the delay engendered by conventional solutions between adjudication of a claim transaction and identification of the transaction as being reimbursed at a loss such that information associated with the transaction may be communicated to a claims processor for review. Conventionally, healthcare providers (e.g., pharmacies) would provide, via paper forms, information relating to healthcare claim transactions that were reimbursed at a loss. This information would be manually entered into appropriate system(s) for communication to a PBM for review. Often, a significant delay would ensue between reimbursement of a claim transaction and identification by the pharmacy that the claim transaction was reimbursed below cost. PBMs typically set time limits beyond which they will not review the appropriateness of the reimbursement amount for a healthcare claim transaction. Accordingly, as a result of the late reporting of claims reimbursed at a loss from pharmacies under conventional solutions, the claims would become outdated by the time they were communicated to a PBM for review and the PBM would refuse to reconsider the reimbursement amount. Thus, embodiments of the disclosure greatly reduce the time between claim adjudication and identification of a claim transaction as being reimbursed at a loss.

In addition, the automation of the filtering and selection processing described herein significantly reduces data errors associated with conventional solutions thereby increasing the likelihood that accurate information is communicated to a PBM when requesting review of the appropriateness of the MAC rate applied for a particular healthcare product. For example, conventionally inexperienced employees at a pharmacy would often indicate inaccurate information when reporting claim transactions reimbursed below cost, and this inaccurate information would be communicated to a PBM as conventional solutions do not include a mechanism for verifying the accuracy of the information. As an example, a pharmacy technician may have indicated the Usual and Customary charge for a healthcare product as $50 and this information would be communicated to a PBM when requesting review of the MAC rate. The PBM would respond that the healthcare claim transaction under consideration was in actuality reimbursed at the Usual and Customary charge of $5, and thus, is not a suitable candidate for assessing the appropriateness of the MAC rate. Such a situation is commonplace with conventional solutions that do not provide an effective mechanism for verifying the accuracy of information manually reported by pharmacies. In contrast, according to embodiments of the disclosure, the reimbursement analysis system receives healthcare claim transaction data that accurately reflects claim adjudication data and performs various automated filtering and selection processing on the healthcare transaction data, thereby significantly reducing the frequency of information errors that occur with conventional solutions.

Yet another technical effect or advantage of embodiments of the disclosure is the unnecessary duplication of healthcare claim transactions communicated to a PBM for MAC rate appropriateness review. Conventional solutions do not include anything akin to the selection processing described herein, and as such, multiple healthcare claim transactions associated with a same healthcare product and reflecting a same MAC rate reimbursement would be communicated to a PBM for review. This inundation with duplicate healthcare claim transactions would overburden the PBM and result in significant processing delays. In contrast, the selection processing performed by the reimbursement system according to embodiments of the disclosure identifies those healthcare claim transactions that are the most suitable candidates for MAC rate reimbursement appropriateness review, and further facilitates selection of representative healthcare claim transactions for communicating to the PBM so as to avoid unnecessary duplication and expedite the PBM's review process.

Yet another technical effect or advantage of the present disclosure is the proactive nature in which healthcare claim transactions reimbursed at a MAC rate below cost are identified and communicated to a PBM for appropriateness review. According to embodiments of the disclosure, such claim transactions may be identified and decisions regarding MAC rate increases may be made prior to healthcare providers even being aware that such transactions are being reimbursed at a MAC rate below cost. Conventional solutions are reactive in nature in that they require the pharmacies to analyze claim transaction data to identify transactions reimbursed at a MAC rate below cost. It should be appreciated that the above examples of technical effects and/or advantages of the present disclosure are merely illustrative and that numerous other technical effects and/or advantages may exist.

The above description of the disclosure is merely illustrative and numerous other embodiments are within the scope of this disclosure. The embodiments described above as well as additional embodiments will be described in greater detail below.

### Illustrative Architecture

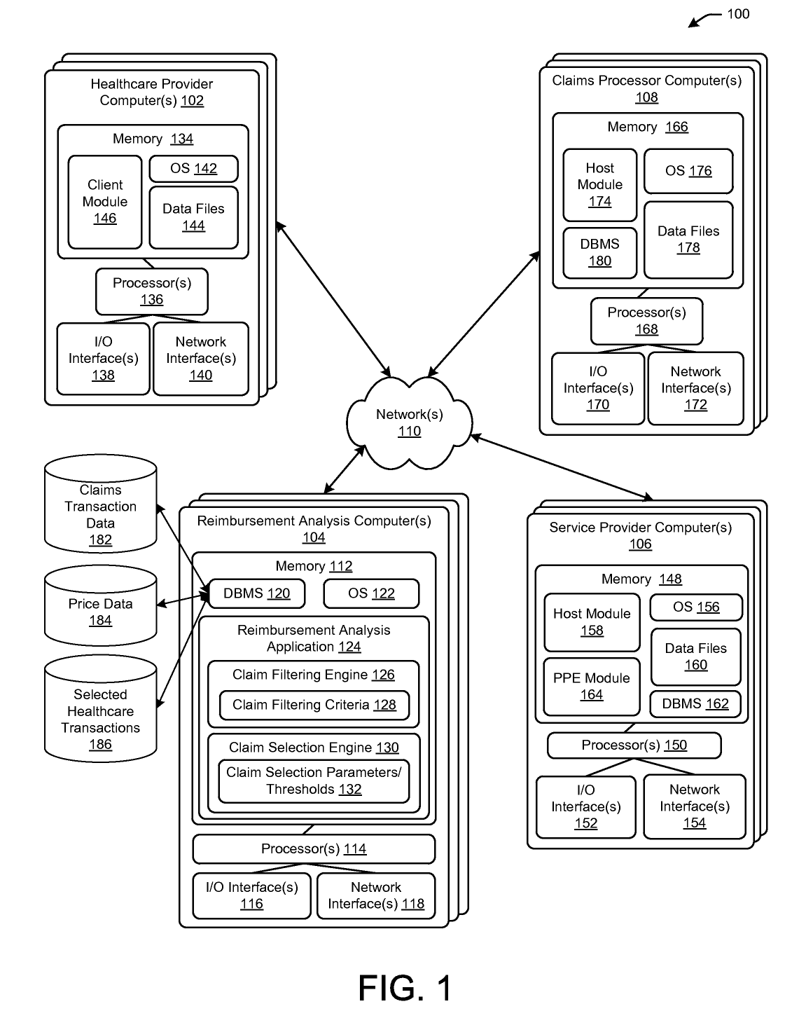

FIG. 1 depicts an illustrative system architecture 100 for identifying healthcare claim transactions reimbursed below cost and performing various filtering and selection processing to further identify those healthcare claim transactions reimbursed below cost that are candidates for requesting or negotiating increases in reimbursement amounts in accordance with one or more embodiments of the disclosure.

As depicted in FIG. 1, the system architecture 100 may include one or more healthcare provider computers 102, one or more reimbursement analysis computers 104, one or more service provider computers 106, and one or more claims processor computers 108. While the one or more healthcare provider computers 102, the one or more reimbursement analysis computers 104, the one or more service provider computers 106, and the one or more claims processor computers 108 may be referred to herein in the singular, it should be appreciated that, depending on the context, a plural number of such components may be provided. Further, one or more of the healthcare provider computers 102 may be associated with a respective healthcare provider (e.g., a pharmacy, a prescriber, etc.) and one or more of the claims processor computers 108 may be associated with a respective claims processor (e.g., a PBM, a private insurer, a public insurer such as a government insurer, a private or public payor, a claims clearinghouse, etc.). Further, any functionality described herein as being supported by the reimbursement analysis computer 104 may, in various embodiments, be supported by a reimbursement analysis system that includes one or more reimbursement analysis computers 104. Accordingly, the terms reimbursement analysis computer 104 and reimbursement analysis system 104 may be used interchangeably herein. The same may hold true for any other components of the illustrative architecture 100 (e.g., the healthcare provider computer 102, the service provider computer 106, the claims processor computer 108).

As desired, the healthcare provider computer 102, the reimbursement analysis computer 104, the service provider computer 106, and/or the claims processor computer 108 may include one or more processing devices that may be configured to access and read computer-readable media having stored computer-executable instructions for implementing various functionality described herein and data manipulated or generated by the execution of such computer-executable instructions. Each of the healthcare provider computer 102, the reimbursement analysis computer 104, the service provider computer 106, and/or the claims processor computer 108 may include networked devices or systems that include or are otherwise associated with suitable hardware and/or software components for transmitting and receiving data and/or computer-executable instructions over one or more communications links or networks. These networked devices and systems may include any number of processors for processing data and executing computer-executable instructions, as well as other internal and peripheral components. Further, these networked devices and systems may include or be in communication with any number of suitable memory devices operable to store data and/or computer-executable instructions. By storing and/or executing computer-executable instructions, each of the networked devices may form a special purpose computer or a particular machine.

As depicted in FIG. 1, the healthcare provider computer 102, the reimbursement analysis computer 104, the service provider computer 106, and/or the claims processor computer 108 may be configured to communicate via one or more networks, such as the network(s) 110, which may include one or more separate or shared private and/or public networks. The network(s) 110 may include, but are not limited to, any one or a combination of different types of suitable communications networks, such as cable networks, the Internet, wireless networks, cellular networks, or any other private and/or public networks. Further, the network(s) 110 may include any type of medium over which network traffic may be transmitted including, but not limited to, coaxial cable, twisted-pair wire, optical fiber, hybrid fiber coaxial (HFC), microwave terrestrial transceivers, radio frequency communications, or satellite communications.

The network(s) 110 may allow for real-time, off-line, and/or batch transactions to be transmitted between or among the healthcare provider computer 102, the reimbursement analysis computer 104, the service provider computer 106, and/or the claims processor computer 108. In one or more embodiments, the illustrative system architecture 100 may be implemented in the context of a distributed computing environment. Further, it should be appreciated that the illustrative system architecture 100 may be implemented in accordance with any suitable network configuration. For example, the network(s) 110 may include a plurality of networks, each with devices such as gateways, routers, linked-layer switches, and so forth for providing connectivity between or among the various devices forming part of the system architecture 100. In some embodiments, dedicated communication links may be used to connect the various devices of the architecture 100. For example, one or more of the service provider computers 106 may serve as a network hub that interconnects the healthcare provider computer 102 and the claims processor computer 108.

The one or more healthcare provider computers 102 may be associated with various types of healthcare providers. For example, one or more of the healthcare provider computers 102 may be associated with an entity (e.g., a pharmacy or pharmacy chain) authorized to dispense medical products and/or provide certain healthcare-related services to patients. Additionally, or alternatively, one or more of the healthcare provider computers 102 may be associated with a prescribing healthcare provider, such as, a physician, hospital, and so forth. The healthcare provider computer 102 may include any suitable processor-driven device that facilitates the generation and processing of healthcare claim transactions or any other healthcare-related transactions.

In one or more embodiments, the healthcare provider computer 102 may be configured to communicate information associated with healthcare claim transactions to the service provider computer 106. In certain embodiments, the healthcare provider computer 102 may be any suitable computing device associated with a healthcare provider, such as a point-of-sale device or a pharmacy management computer associated with a pharmacy, a practice management computer associated with a physician's office, clinic or hospital, and so forth. By storing and/or executing computer-executable instructions, the healthcare provider computer 102 may form a special purpose computer or other particular machine that is operable to facilitate the processing of healthcare requests submitted by patients in order to generate healthcare claim transactions based on the healthcare requests and to transmit the generated healthcare claim transactions to the service provider computer 106. In certain embodiments of the disclosure, operations performed by the healthcare provider computer 102 may be distributed among several processing components.

According to one or more illustrative embodiments of the disclosure, a healthcare claim transaction generated by the healthcare provider computer 102 and received by the service provider computer 106 may be formatted in accordance with a version of a National Council for Prescription Drug Programs (NCPDP) Telecommunication Standard, although other standards may be utilized as well. The healthcare claim transaction may include a Bank Identification Number (BIN) and/or a Processor Control Number (PCN) for identifying a particular claims processor computer or payer, such as the claims processor computer 108, as an intended recipient of the transaction. In addition, the healthcare claim transaction may include information identifying a patient, payor (e.g., a PBM), prescriber, healthcare provider and/or the healthcare product to which the transaction relates. An illustrative healthcare claim transaction may include one or more of the following types of information:

Payor ID/Routing Information
BIN Number (i.e. Bank Identification Number) and/or
Processor Control Number (PCN) that designates a destination of the healthcare claim transaction

Patient Information

Name (e.g., Patient Last Name, Patient First Name, etc.)

Date of Birth of Patient

Gender Identification

Patient Address (e.g., Street Address, Zip Code, etc.)

Patient Contact Information (e.g., Patient Telephone Number, email address, etc.)

Patient Health Condition Information

Patient ID or other identifier

Insurance/Coverage Information
Cardholder Name (e.g., Cardholder First Name, Cardholder Last Name)
Cardholder ID and/or other identifier (e.g., person code)
Group ID and/or Group Information
State Payor Information
Prescriber Information
Primary Care Provider ID or other identifier (e.g., NPI code)
Primary Care Provider Name (e.g., Last Name, First Name)
Prescriber ID or other identifier (e.g., NPI code, DEA number)
Prescriber Name (e.g., Last Name, First Name)
Prescriber Contact Information (e.g., Telephone Number)
Pharmacy or other Healthcare Provider Information (e.g., store name, chain identifier, etc.)
Pharmacy or other Healthcare Provider ID (e.g., National Provider Identifier (NPI) code)

Claim Information
Drug or product information (e.g., National Drug Code (NDC)
Prescription/Service Reference Number
Date Prescription Written
Quantity Dispensed
Days Supply
Refills Authorized
Diagnosis/Condition
Pricing information for the healthcare product (e.g., contracted rate, Usual & Customary rate, Ingredient Cost Submitted rate, etc.)
One or more NCPDP Message Fields
One or more Drug Utilization Review (DUR) Codes
Date of Service.

Upon receipt of a healthcare claim transaction from the healthcare provider computer 102, the service provider computer 106 may be configured to process the transaction in any suitable manner including performing various pre-edits to the transaction and/or making any of variety of determinations with respect thereto. The pre-edits that may be performed may involve verifying, adding and/or editing information included in the healthcare claim transaction. Processing of the healthcare claim transaction by the service provider computer 106 may result in any of a variety of further communication with the healthcare provider computer 102 prior to routing of the transactions to the claims processor computer 108. For example, the service provider computer 106 may reject a transaction based on any of a variety of determinations, generate a rejection message, and communicate the rejection message to the healthcare provider computer 102. In certain embodiments, the healthcare provider computer 102 may receive the rejection message and resubmit the healthcare transaction potentially with override information to override the rejection. In other embodiments, the healthcare provider computer 102 may generate and communicate a new healthcare transaction to the service provider computer 106 responsive to the rejection.

According to one or more embodiments of the disclosure, upon determining that the healthcare claim transaction is appropriate for routing, the service provider computer 106 may utilize at least a portion of the information included in the transaction, such as, for instance, a BIN/PCN, to determine the appropriate claims processor computer 108 to which to route the transaction. The service provider computer 106 may also utilize a routing table, perhaps stored in memory, to determine the network location of the appropriate claims processor computer 108.

The claims processor computer 108 may receive, adjudicate and/or otherwise process the healthcare claim transaction received from the service provider computer 106. For example, the claims processor computer 108 may perform an adjudication process for determining benefits coverage with respect to eligibility, pricing and/or utilization review. The adjudication process may involve determining whether the patient associated with the healthcare claim transaction is eligible for reimbursement for the dispensed healthcare product under the patient's insurance plan, and if so, the amount of the claim that will be reimbursed. The claims processor computer 108 may then communicate an adjudicated response to the service provider computer 106. As previously noted, the healthcare claim transaction routed to the claims processor computer 108 from the healthcare provider computer 102 via the service provider computer 106 may take the form of an adjudication request data segment. The adjudication response from the claims processor computer 108 may take the form of an adjudication response data segment including information identifying the eligibility determination and the reimbursement amount that is appended to the request data segment. The claims processor computer 108 may communicate a combined data packet including both the adjudication request data segment and the adjudication response data segment to the service provider computer 106.

As desired, upon receipt of the adjudication response from the claims processor computer 108, the service provider computer 106 may perform any number of post-edits on the adjudicated response. The adjudicated response may then be routed or otherwise communicated by the service provider computer 106 to the healthcare provider computer 102.

The illustrative architecture 100 may further include a reimbursement analysis system that comprises one or more reimbursement analysis computers 104. While the following discussion may be presented through reference to a reimbursement analysis computer 104, it should be appreciated that the discussion is intended to encompass a reimbursement analysis system that includes one or more of the reimbursement analysis computers 104 and any of a variety of other system components. The reimbursement analysis computer 104 may receive healthcare claim transaction data relating to adjudicated healthcare claim transactions from any of a variety of data sources. For example, in various embodiments, the reimbursement analysis computer 104 may receive healthcare claim transaction data from the service provider computer 106. The service provider computer 106 may store information associated with healthcare claim transactions that are routed through the service provider computer 106 and may provide this information to the reimbursement analysis computer 104 in any of a variety of ways including, but not limited to, via a data stream received by the reimbursement analysis computer 104 on a batch and/or real-time basis, by storing the information in one or more shared datastore(s) accessible by the reimbursement analysis computer 104, and so forth. Communicative coupling of the reimbursement analysis computer 104 and the service provider computer 106 may facilitate receipt of the healthcare claim transaction data via one or more of the network(s) 110.

The reimbursement analysis computer 104 may also receive healthcare claim transaction data from healthcare provider computers 102 associated with various healthcare providers. For example, healthcare claim transaction data relating to adjudicated healthcare claim transactions may be harvested from a variety of healthcare provider computers 102 and transmitted to the reimbursement analysis computer 104 via one or more of the network(s) 110 in data streams received on a batch and/or real-time basis. Alternatively, or additionally, the healthcare claim transaction data gathered from a variety of healthcare providers may be stored in one or more shared datastores accessible by the reimbursement analysis computer 104. In certain embodiments, the healthcare claim transaction data may be received as one or more data files according to any suitable file format. However, embodiments of the disclosure are not so limited and the healthcare claim transaction data may be received in any suitable form or format.

The reimbursement analysis system may also receive price data from one or more data sources. The price data may include data relating to a respective acquisition price or cost associated with each of a variety of healthcare products. The respective acquisition cost identified for each healthcare product may, in certain embodiments, represent an average acquisition cost. An average acquisition cost may be used to account for variation between geographic regions and healthcare providers (e.g., pharmacies). As with the healthcare claim transaction data, the price data may be similarly received on a batch and/or real-time basis and may be received from any suitable data source including, but not limited to, the service provider computer 106, the healthcare provider computer 102, a system hosted or managed by other third parties, and so forth.

Upon receipt of the healthcare claim transaction data and/or the price data, the reimbursement analysis computer 104 may perform various optional processing on the data (e.g., parse the data) and store the processed data in one or more datastores. While FIG. 1 depicts the healthcare claim transaction data and the price data as being may be stored in separate sets of one or more datastores (datastore(s) 182 and datastore(s) 184, respectively), in certain embodiments, at least a portion of the healthcare claim transaction data and at least a portion of the price data may be stored in at least one same datastore.

Referring again to the reimbursement analysis computer 104, the healthcare provider computer 102 may include one or more memory devices 112 (generically referred to herein as memory 112), one or more processors 114 configured to execute computer-executable instructions that may be stored in the memory 112, one or more input/output (“I/O”) interface(s) 116, and/or one or more network interface(s) 118. The reimbursement analysis computer 104 may be any suitable processor-driven device including, but not limited to, a server, a desktop computer, a mobile computing device, a mainframe computer, and so forth. The processor(s) 114 may include any suitable processing unit capable of accepting digital data as input, processing the input data in accordance with stored computer-executable instructions, and generating output data. The processor(s) 114 may be configured to execute the computer-executable instructions to cause or facilitate the performance of various operations. The processor(s) 114 may include any type of suitable processing unit including, but not limited to, a central processing unit, a microprocessor, a Reduced Instruction Set Computer (RISC), a Complex Instruction Set Computer (CISC), a microprocessor, a microcontroller, an Application Specific Integrated Circuit (ASIC), a Field-Programmable Gate Array (FPGA), a System-on-a-Chip (SoC), and so forth.

The memory 112 may store computer-executable instructions that are loadable and executable by the processor(s) 114, as well as data manipulated and/or generated by the processor(s) 114 during the execution of the computer-executable instructions. The memory 112 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 112 may include multiple types of memory, such as static random access memory (SRAM), dynamic random access memory (DRAM), unalterable ROM, and/or writeable variants of ROM such as electrically erasable programmable read-only memory (EEPROM), flash memory, and so forth.

The memory 112 may store data, computer-executable instructions, and/or various program modules including, for example, a database management system (DBMS 120), one or more operating systems 122, and/or a reimbursement analysis application 124. The operating system (O/S) 122 may provide an interface between other application software executing on the reimbursement analysis computer 104 and hardware resources of the computer 104. More specifically, the O/S 122 may include a set of computer-executable instructions for managing hardware resources of the reimbursement analysis computer 104 and for providing common services to other application programs (e.g., managing memory allocation among various application programs). The O/S 122 may include any operating system now known or which may be developed in the future including, but not limited to, a Microsoft Windows® operating system, an Apple OSX™ operating system, Linux, Unix, a mainframe operating system such as Z/OS, a mobile operating system, or any other proprietary or freely available operating system.

The one or more I/O interfaces 116 may facilitate receipt by the reimbursement analysis computer 104 of information input from one or more I/O devices as well as the output of information from the computer 102 to the one or more I/O devices. The I/O devices may include, for example, one or more user interface devices that facilitate interaction between a user and the reimbursement analysis computer 104 including, but not limited to, a display, a keypad, a control panel, a touch screen display, a remote control device, a microphone, and so forth. As a non-limiting example, the one or more I/O interfaces 116 may facilitate interaction between a user and the reimbursement analysis application 124 to facilitate performance of various filtering and selection processing on healthcare claim transaction data. The reimbursement analysis computer 104 may further include one or more network interfaces 118 that may facilitate communication between the reimbursement analysis computer 104 and other devices within the networked architecture 100 via one or more of the network(s) 110. For example, the network interface(s) 118 may facilitate receipt of the healthcare claim transaction data and/or the price data by the reimbursement analysis computer 104.

As previously noted, the operations of the reimbursement analysis computer 104 may be controlled by computer-executable or computer-implemented instructions that are executed by the one or more processors 114 associated with the reimbursement analysis computer 104 to form a special purpose computer or other particular machine that is operable to facilitate the receipt, routing, and/or processing of healthcare transactions. The one or more processors 114 that control the operations of the service provider computer 106 may be incorporated into the service provider computer 106 or may be in communication with the service provider computer 106 via one or more suitable networks. In certain embodiments of the disclosure, the operations and/or control of the service provider computer 106 may be distributed among several processing components.

The reimbursement analysis application 124 may include various sub-modules or engines such as, for example, a claim filtering engine 126 and a claim selection engine 130. The claim filtering engine 126 and the claim selection engine 130 may each include computer-executable instructions that upon execution by the processor(s) 114 may cause various respective filtering and selection processing to be performed on the healthcare claim transaction data stored, for example, in the datastore(s) 182. For example, the claim filtering engine 126 may include computer-executable instructions for performing, potentially responsive to user input, i) the first filtering operation for identifying a first group of healthcare claim transactions from the healthcare claim transaction data that were reimbursed at a loss and ii) the second filtering operation for identifying a second group of healthcare claim transactions among the first group by excluding those healthcare claim transactions that were reimbursed at a loss as a result of the reimbursement level being a Usual and Customary rate, a contracted rate, an Ingredient Cost Submitted rate, or the like that was less than the MAC rate.

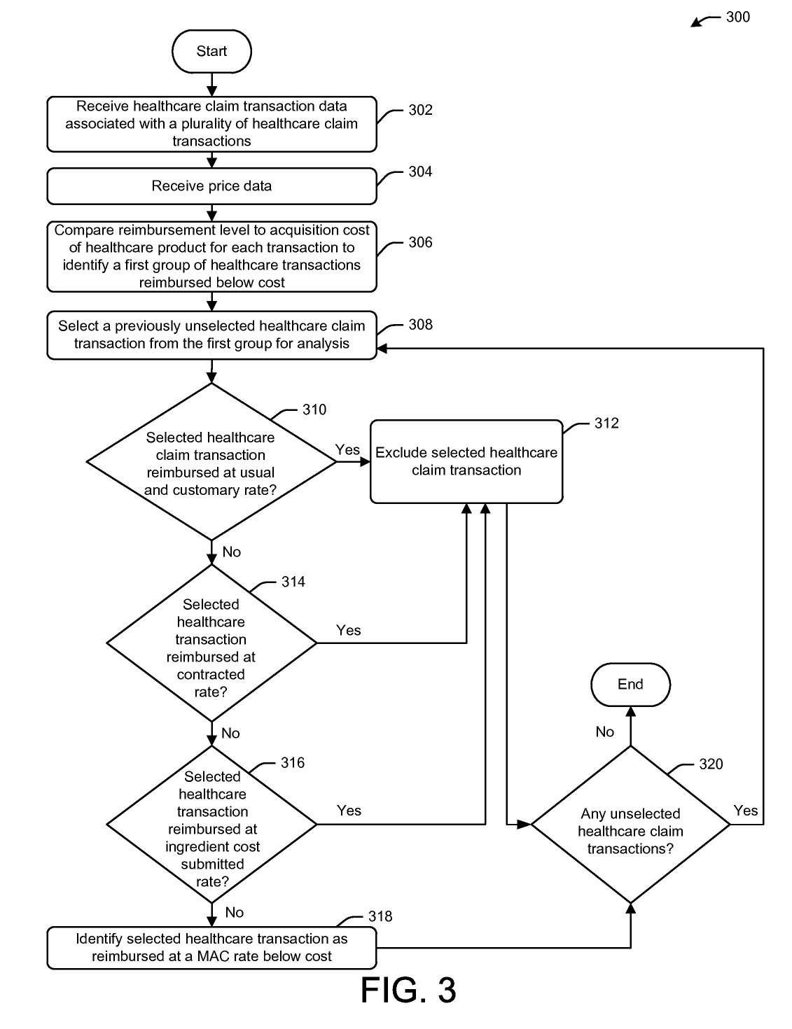

The claim filtering engine 126 may utilize various claim filtering criteria 128 to perform the first and second filtering operations. For example, in connection with the first filtering operation, the filtering criteria 128 may include information specifying that, for each healthcare claim transaction for which data is available, the associated healthcare product is to be identified and compared to an acquisition cost of the product as specified in the price data stored in the one or more datastore(s) 184. Similarly, in connection with the second filtering operation, the filtering criteria 128 may specify various types of reimbursement amounts other than the MAC rate. The filtering engine 126 may utilize this information to identify, among those healthcare claim transactions reimbursed below cost, the transactions that were reimbursed at a reimbursement level (e.g., Usual and Customary rate, contracted rate, etc.) that does not correspond to the MAC rate and to exclude or filter out those transactions such that only the transactions presumably reimbursed at a MAC rate below cost remain among the filtered healthcare transactions. A manner of operation of the filtering engine 126 for performing the second filtering operation will be described in more detail through reference to FIG. 3. While the filtering engine 126 and the processing that it enables have been described as forming part of or being supported by the reimbursement analysis application 124, in various embodiments, the filtering operations may be performed by an independent scheduled software process responsive to receipt of the healthcare claim transaction data and the price data.

The reimbursement analysis application 124 may further include a claim selection engine 130 that may comprise computer-executable instructions for performing various selection processing on the filtered healthcare claim transactions. In various embodiments, the filtering operations may reveal numerous healthcare products having associated healthcare claim transactions that were reimbursed at a MAC rate below acquisition cost. As previously described, it may not be practical to provide a claims processor with representative healthcare claim transactions associated with each such product in order to request MAC rate increases as this may inundate the claims processor with requests and delay the processing of such requests. Rather, in various embodiments, it may be more expedient to identify those healthcare products associated with below cost MAC rate reimbursements that are the strongest potential candidates for obtaining a MAC rate increase. As such, the selection processing may be performed to identify healthcare claim transactions that are the strongest candidates for requesting a MAC rate increase for an associated healthcare product.

As part of the selection processing, claim selection parameters 132 associated with healthcare products may be compared to associated selection parameter thresholds 132 in order to identify those healthcare products for which a MAC rate increase would be most appropriate or desired. The selection parameters 132 that may be used to identify suitable candidate healthcare claim transactions may include, but are not limited to, net loss, a metric associated with net loss (e.g., an average net loss), margin loss, a metric associated with margin loss (e.g., an average margin loss), a total number of healthcare claim transactions reimbursed below cost for a particular healthcare product, and so forth. The selection parameters 132 may be compared to associated selection parameter thresholds in order to determine those healthcare product(s) for which the threshold is met, thereby making healthcare claim transactions associated with those product(s) suitable candidates for use in requesting an increase in the MAC rate. The associated selection parameter thresholds to which the selection parameters 132 may be compared may include, but are not limited to, a threshold percentage of the acquisition cost of a healthcare product, a threshold difference between the acquisition cost and the reimbursement level, a threshold number of healthcare transactions reimbursed below cost, and so forth.

In certain embodiments, the particular selection parameter 132 used for making an assessment with respect to the candidacy of a particular healthcare product may be based, at least in part, on one or more characteristics associated with the healthcare product. For example, a selection parameter corresponding to margin loss or average margin loss may be a more appropriate parameter for measuring the extent of loss for generic products, whereas a selection parameter corresponding to net loss or average net loss may be more appropriate for branded products. In certain embodiments, the total number of healthcare claim transactions reimbursed at a MAC rate below acquisition cost may be an appropriate selection parameter for consideration. For example, there may exist scenarios in which neither the margin loss nor the net loss is significant for each healthcare claim transaction associated with a particular healthcare product; however, the sheer number of such healthcare claim transactions may justify requesting a MAC rate increase for that healthcare product.

In certain embodiments, the selection processing supported by the claim selection engine 130 may be performed on a per-claim basis. For example, each filtered healthcare claim transaction may be analyzed to determine whether a selection parameter associated with the transaction (e.g., a margin loss, a net loss, etc.) meets or exceeds a corresponding threshold, and if such a determination is in the affirmative, the healthcare claim transaction may be identified as a candidate healthcare claim transaction for use in requesting an increase in the MAC rate associated with the corresponding healthcare product. In other embodiments, the selection processing supported by the claim selection engine 130 may include analyzing the filtered healthcare claim transactions associated with a particular healthcare product on an aggregate basis. For example, the average margin loss or average net loss associated with all filtered healthcare transactions corresponding to a particular healthcare product may be compared to an associated threshold such as a margin loss threshold (e.g., a threshold percentage of the acquisition cost of the healthcare product) or a net loss threshold (e.g., a threshold difference between the MAC rate reimbursement level and the acquisition cost of the healthcare product) to identify those healthcare products that are suitable candidates for requesting an increase in associated MAC rates. As yet another non-limiting example of analysis with respect to an aggregate of filtered healthcare claim transactions, the total number of filtered healthcare claim transactions associated with a particular healthcare product may be analyzed to determine whether the number of transactions meets or exceeds an associated threshold number of transactions, and if so, that healthcare product may be identified as a candidate for requesting an increase in the MAC rate.

It should be appreciated that the above examples of selection parameters, selection parameter thresholds, and selection processing mechanisms utilizing the selection parameters and associated thresholds are merely illustrative and that other parameters, parameter thresholds, and associated selection processing mechanisms are within the scope of this disclosure.

In various embodiments, as a result of the selection processing supported by the claim selection engine 130, a third group of healthcare claim transactions may be identified from the second group of healthcare transactions described earlier. The third group of healthcare claim transactions may include each healthcare claim transaction associated with a healthcare product determined to be a suitable candidate for requesting a MAC rate increase (based for example on the aggregate selection processing described above). Alternatively, the third group of healthcare claim transactions may include each healthcare claim transaction for which a corresponding selection parameter is determined to meet or exceed an associated selection parameter threshold (based for example on the per-claim selection processing described earlier).

Upon identification of one or more healthcare products associated with healthcare claim transactions having MAC rate reimbursement levels that satisfy associated selection parameter thresholds, further selection processing may be supported by the claim selection engine 130 to identify, based at least in part on one or more selection criteria, one or more representative healthcare claim transactions for submission to an appropriate claims processor as part of a request for a MAC rate increase. The selection criteria may include any suitable criterion including, but not limited to, a largest net loss, a largest margin loss, and so forth. In certain embodiments, one or more representative healthcare claim transactions may be selected for each healthcare product identified as a candidate for requesting an increase in the MAC rate. However, in certain other embodiments, a representative healthcare claim transaction may not be selected for each candidate healthcare product. For example, in certain embodiments, a healthcare claim transaction associated with the largest margin loss or the largest net loss across all candidate healthcare products or some subset of candidate healthcare products may be selected for use in requesting an increase in MAC rates.

In various embodiments, the reimbursement analysis application 124 may provide an indication of the candidate healthcare claim transactions identified as a result of the selection processing. The indication may be, for example, a graphical, textual, or other visual indication of the candidate healthcare transactions that may be presented to the user via a user interface of the reimbursement analysis application 124. In certain embodiments, the user of the application may proceed to select one or more representative healthcare claim transactions from the candidate healthcare claim transactions to present to a claims processor for requesting a MAC rate increase. The selection of representative healthcare claim transaction(s) may be manual or may be an automated process based on one or more selection criteria.

Upon selection of representative healthcare transactions, the reimbursement analysis application 124 may import the selected representative healthcare transactions into a database table, data file or otherwise aggregate the selected transactions for communication to an appropriate claims processor on a batch basis. The selected representative healthcare claim transactions may be stored, for example, in one or more datastores 186. The selected healthcare claim transactions and/or associated information may be communicated to an appropriate claims processor computer 108 via one or more of the network(s) 110 on a batch and/or real-time basis for requesting review of associated MAC rates.

The claims processor computer 108 may communicate one or more response messages to the reimbursement analysis computer 104 responsive to receipt of the representative healthcare claim transactions and associated information. The response message(s) may include an indication, for each healthcare product for which a representative healthcare claim transaction was received, whether the MAC rate associated with that healthcare product has been increased. In certain embodiments, an amount of increase in the MAC rate may be indicated, while in other embodiments, only an indication that the rate has been increased may be provided. For those healthcare products for which the claims processor has determined not to increase the MAC rate, the response message(s) may further provide an indication of one or more reasons as to why the MAC rate was not increased. Various reasons may be provided in connection with a determination not to increase a MAC rate. For example, “MAC not raised due to utilization” may be provided as a reason for not increasing the MAC rate of a particular healthcare product when it is determined that another healthcare product, while not generically equivalent to the dispensed product (e.g., contains a different active ingredient), should have been dispensed in lieu of the product that was dispensed. In another non-limiting example, the claims processor may determine not to raise the MAC rate for a healthcare product because the claims processor believes the product is available for less on the market than the cost paid by the healthcare provider such as, for example, from a wholesaler. As yet another non-limiting example, the claims processor may indicate that a representative healthcare transaction was not considered for a MAC rate increase because the transaction was reversed by the healthcare provider, which may be the case if, for example, the patient did not pick up a filled prescription. In such scenarios, one or more additional representative healthcare claim transactions associated with the same healthcare product may be identified and communicated to the claims processor for requesting a MAC rate increase. Further, in certain embodiments, multiple representative healthcare claim transactions for a particular healthcare product may be proactively communicated to a claims processor in order to account for the possibility that one or more of the healthcare claim transactions may be reversed. In addition, multiple representative healthcare claim transactions associated with a particular product may also be communicated to a claims processor in those situations in which the number of candidate healthcare claim transactions associated with that product meets or exceeds a threshold number of transactions in order to emphasize the urgency of the review of the adequacy of the MAC rate. Moreover, information indicating that the representative healthcare claim transactions are representative of a much larger number of transactions may also be communicated to the claims processor to emphasize the amount of loss that is being generated.

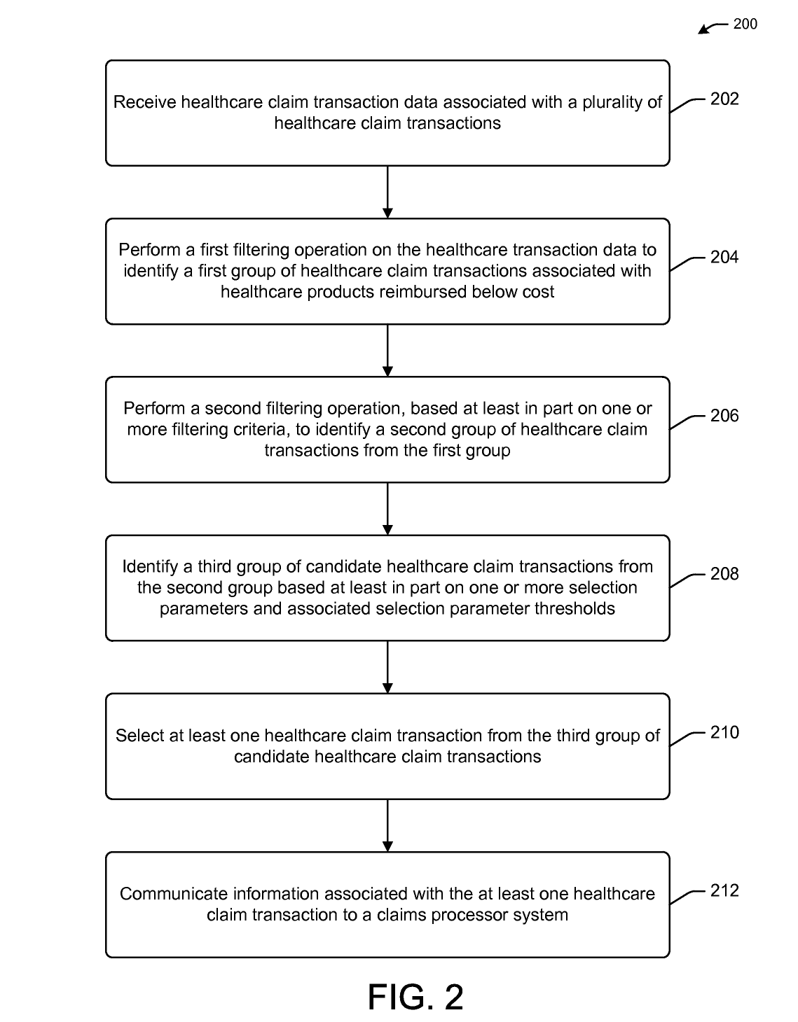

In various embodiments, upon receiving the response message(s) from the claims processor computer 108, information relating to those MAC rate(s) that have been increased and/or information relating to those MAC rate(s) that have not been increased may be communicated to appropriate healthcare provider computers 102. The information may be communicated from the reimbursement analysis computer 104 to the healthcare provider computer(s) 102 via a data stream on a batch and/or real-time basis or may be published to a location accessible by the healthcare provider computer(s) 102. The functionality supported by the reimbursement analysis application 124 including the functionality supported by the claim filtering engine 126 and the claim selection engine 130 will be described in greater detail through reference to the illustrative methods depicted in FIGS. 2-5.

Referring again to the other illustrative components of the illustrative networked architecture 100, the healthcare provider computer 102 may include one or more memory devices 134 (generically referred to herein as memory 134), one or more processors 136 configured to execute computer-executable instructions that may be stored in the memory 134, one or more input/output (“I/O”) interface(s) 138, and/or one or more network interface(s) 140. The healthcare provider computer 102 may be any suitable processor-driven device including, but not limited to, a server, a desktop computer, a mobile computing device, a mainframe computer, and so forth. The processor(s) 136 may include any suitable processing unit capable of accepting digital data as input, processing the input data in accordance with stored computer-executable instructions, and generating output data. The processor(s) 136 may be configured to execute the computer-executable instructions to cause or facilitate the performance of various operations. The processor(s) 136 may include any type of suitable processing unit including, but not limited to, a central processing unit, a microprocessor, a Reduced Instruction Set Computer (RISC), a Complex Instruction Set Computer (CISC), a microcontroller, an Application Specific Integrated Circuit (ASIC), a Field-Programmable Gate Array (FPGA), a System-on-a-Chip (SoC), and so forth.

The memory 134 may store computer-executable instructions that are loadable and executable by the processor(s) 136, as well as data manipulated and/or generated by the processor(s) 136 during the execution of the computer-executable instructions. The memory 134 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 134 may include multiple different types of memory, such as static random access memory (SRAM), dynamic random access memory (DRAM), unalterable ROM, and/or writeable variants of ROM such as electrically erasable programmable read-only memory (EEPROM), flash memory, and so forth.

The memory 134 may store data, computer-executable instructions, and/or various program modules including, for example, one or more operating systems 142, data files 144, and/or a client module 146. The operating system (O/S) 142 may provide an interface between other application software executing on the healthcare provider computer 102 and hardware resources of the computer. More specifically, the O/S 142 may include a set of computer-executable instructions for managing hardware resources of the healthcare provider computer 102 and for providing common services to other application programs (e.g., managing memory allocation among various application programs). The O/S 142 may include any operating system now known or which may be developed in the future including, but not limited to, a Microsoft Windows® operating system, an Apple OSX™ operating system, Linux, Unix, a mainframe operating system such as Z/OS, a mobile operating system, or any other proprietary or freely available operating system.

The data files 144 may include any suitable information that may be utilized by the healthcare provider computer 102 to process healthcare requests and/or generate healthcare transactions, such as, for example, patient profiles, patient insurance information, and so forth. For example, the data files 144 may include, but are not limited to, healthcare information and/or contact information associated with one or more patients, information associated with the service provider computer 106, information associated with one or more claims processors, information associated with one or more payors or other entities providing medical benefits coverage, information associated with one or more healthcare requests and/or transactions, or potentially other information.

The client module 146 may be an Internet browser or other suitable software application (e.g., a dedicated desktop or mobile application, a web-based application, etc.) that provides functionality that allows for interaction with other components of the illustrative architecture 100 (e.g., the reimbursement analysis computer 104, the service provider computer 106, etc.) As a non-limiting example, a user such as a pharmacist or other pharmacy employee may utilize functionality supported by the client module 146 to generate a prescription claim transaction for transmission to the service provider computer 106. Upon receipt of the healthcare claim transaction, the service provider computer 106 may then route the transaction to an intended recipient (e.g., an appropriate claims processor computer 108) for adjudication. The client module 146 may also support functionality making healthcare claim transaction data associated with adjudicated healthcare transactions available to the reimbursement analysis computer 104.

The one or more I/O interfaces 138 may facilitate communications between the healthcare provider computer 102 and one or more input/output devices, such as, for example, one or more user interface devices that facilitate interaction between a user and the healthcare provider computer 102 including, but not limited to, any of those described previously. As a non-limiting example, the one or more I/O interfaces 138 may facilitate input of information associated with a healthcare transaction or a healthcare request by a user (e.g., a pharmacist, a pharmacy employee, a physician, a physician's office employee, etc.). The healthcare provider computer 102 may further include one or more network interfaces 140 that may facilitate communications between the healthcare provider computer 102 and other devices within the networked architecture 100 via one or more of the network(s) 110.

Referring now to other illustrative components of the illustrative architecture 100, the service provider computer 106 may include, but is not limited to, any suitable processor-driven device that is configured to receive, process, route, and/or fulfill healthcare claim transactions received from the healthcare provider computer 102 and/or adjudicated responses thereto received from the claims processor computer 108. For example, the service provider computer 106 may include, but is not limited to, a server, a desktop computer, a mobile computing device, a mainframe computer, and so forth. The healthcare transactions may be associated with any of a prescription for a medication or other medical product, a determination of healthcare benefits, a prior authorization for a medical product or service, a healthcare-related service provided by a pharmacist, other pharmacy employee, physician, nurse, or other healthcare provider, and so forth. In certain embodiments, at least one service provider computer 106 may be a switch/router that routes healthcare transactions between the healthcare provider computer 102 and the service provider computer 106. For example, the service provider computer 106 may route billing transactions and/or prescription claim transactions received from the healthcare provider computer 102 to a claims processor computer 108 associated with, for example, a PBM, an insurer, a government payor, or other third-party payor. In certain embodiments, the service provider computer 106 may include a suitable host server, host module or other software application or module that facilitates receipt of a healthcare transaction from a healthcare provider computer 102 and/or routing of the received healthcare transaction to an appropriate claims processor computer 108. Any number of healthcare provider computers 102 and/or claims processor computers 108 may be configured to communicate with any number of service provider computers 106 according to various embodiments of the disclosure.

In certain embodiments, the operations of the service provider computer 106 may be controlled by computer-executable or computer-implemented instructions that are executed by one or more processors associated with the service provider computer 106 to form a special purpose computer or other particular machine that is operable to facilitate the receipt, routing, and/or processing of healthcare transactions. The one or more processors that control the operations of the service provider computer 106 may be incorporated into the service provider computer 106 or may be in communication with the service provider computer 106 via one or more suitable networks. In certain embodiments of the disclosure, the operations and/or control of the service provider computer 106 may be distributed among several processing components.

Referring now more specifically to various illustrative components of the service provider computer 106, the computer 106 may include one or more memory devices 148 (referred to herein generically as memory 148), one or more processors 150 configured to access the memory 148 and execute computer-executable instructions stored therein, one or more I/O interfaces 152, and/or one or more network interfaces 154. The processor(s) 150 may include any suitable processing unit capable of accepting digital data as input, processing the input data in accordance with stored computer-executable instructions, and generating output data. The processor(s) 150 may be configured to execute the computer-executable instructions to cause various operations to be performed. The processor(s) 150 may include any type of suitable processing unit including, but not limited to, a central processing unit, a microprocessor, a Reduced Instruction Set Computer (RISC), a Complex Instruction Set Computer (CISC), a microcontroller, an Application Specific Integrated Circuit (ASIC), a Field-Programmable Gate Array (FPGA), a System-on-a-Chip (SoC), and so forth.

The memory 148 may store program instructions that are loadable and executable by the processor(s) 150, as well as data manipulated and/or generated by the processor(s) 150 during the execution of the program instructions. The memory 148 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 148 may include multiple different types of memory, such as static random access memory (SRAM), dynamic random access memory (DRAM), unalterable ROM, and/or writeable variants of ROM such as electrically erasable programmable read-only memory (EEPROM), flash memory, and so forth.

The memory 148 may store data, executable instructions, and/or various program modules utilized by the service provider computer 106 such as, for example, one or more operating systems (“O/S”) 156, a host module 158, data files 160, a DBMS 162 to facilitate management of the data files 160 and/or other data stored in the memory 148 and/or data stored in one or more datastores (not shown), and a pre-and-post edit (PPE) module 164.

The data files 160 of the service provider computer 106 may include healthcare transaction records associated with communications received from various healthcare provider computers 102 and/or various claims processor computers 108. The data files 160 may further include any other information associated with healthcare transactions received by the service provider computer 106. For example, the data files 160 may include healthcare information and/or contact information associated with one or more patients such as patient profiles or patient insurance information, information associated with one or more claims processors, information associated with one or more healthcare transactions, or potentially other information. The data files 160 may also include any number of suitable routing tables that facilitate the determination of destinations of communications received from the healthcare provider computer 102 and/or the claims processor computer 108. In addition, in certain embodiments, the service provider computer 106 may support functionality for routing communications between the healthcare provider computer 102 and the reimbursement analysis computer 104 and/or between the claims processor computer 108 and the reimbursement analysis computer 104. Accordingly, the data files 160 may further include information associated with representative healthcare claim transactions received from the reimbursement analysis computer 104 for routing to the claims processor computer 108, information associated with responses received from the claims processor computer 108 for routing to the reimbursement analysis computer 104, and/or information associated with MAC rate determinations by a claims processor for routing between the reimbursement analysis computer 104 and various healthcare provider computers 102.

The (O/S) 156 may include one or more program modules that control the general operation of the service provider computer 106. The O/S 156 may manage the use of hardware resources by and facilitate the execution by the processor(s) 150 of computer-executable instructions provided as part of various software modules such as, for example, the host module 158, the DBMS 162, and/or the PPE module 164. The O/S 156 may include any suitable operating system now known or which may be developed in the future including, but not limited to, a Microsoft Windows® operating system, an Apple OSX™ operating system, a Linux-based operating system, a Unix-based operating system, or a mainframe operating system.

The host module 158 may be configured to receive, process, route, and/or respond to requests received from the client module 146 of the healthcare provider computer 102. Additionally, the host module 158 may be configured to receive, process, route, and/or respond to requests received from a host module 174 of the claims processor computer 108. The PPE module 164 may be operable to perform one or more pre-edits on a received healthcare transaction prior to routing or otherwise communicating the healthcare transaction to a suitable claims processor computer 108 or other intended recipient. Additionally, the PPE module 164 may be operable to perform one or more post-edits on an adjudicated response that is received from a claims processor computer 108 for a healthcare transaction prior to routing the adjudicated response, or an indication thereof, to the healthcare provider computer 102.

The service provider computer 106 may also include one or more I/O interfaces 152 that may facilitate communication between the service provider computer 106 and one or more input/output devices such as, for example, one or more user interface devices including, but not limited to, a display, a keypad, a control panel, a touch screen display, a remote control, a microphone, etc. that may facilitate user interaction with the service provider computer 106. The service provider computer 106 may also include one or more network interfaces 154 that may facilitate communication of the service provider computer 106 with various other components of the illustrative architecture 100 via one or more of network(s) 110.

Referring now to other illustrative components of the illustrative architecture 100, the claims processor computer 108 may be any suitable processor-driven device that facilitates receiving, processing and/or fulfilling healthcare transactions received from the service provider computer 106 and/or receipt of healthcare transactions for MAC rate reimbursement review from the reimbursement analysis computer 104, potentially via the service provider computer 106. For example, the claims processor computer 108 may be a processor-driven device associated with a pharmacy benefits manager (PBM), an insurer, a government payor, a claims clearinghouse, and so forth. The claims processor computer 108 may include any number of special purpose computers or other particular machines, application specific circuits, microcontrollers, personal computers, minicomputers, mainframe computers, servers, or the like. In certain embodiments, the operations of the claims processor computer 108 may be controlled by computer-executable or computer-implemented instructions that are executed by one or more processors associated with the claims processor computer 108 to form a special purpose computer or other particular machine that is operable to facilitate the receipt, routing, and/or processing of healthcare transactions received from the service provider computer 106 as well as the receipt, routing and processing of representative healthcare claim transactions as part of review of the appropriateness of the MAC rates for healthcare products. The one or more processors that control the operations of the claims processor computer 108 may be incorporated into the claims processor computer 108 and/or may be in communication with the claims processor computer 108 via one or more of the network(s) 110. In certain embodiments of the disclosure, the operations and/or control of the claims processor computer 108 may be distributed among several processing components.

Referring now more specifically to various illustrative components of the claims processor computer 108, the computer 108 may include one or more memory devices 166 (referred to herein generically as memory 166), one or more processors 168 configured to access the memory 166 and execute computer-executable instructions stored therein, one or more I/O interfaces 170, and/or one or more network interfaces 172. The processor(s) 168 may include any suitable processing unit capable of accepting digital data as input, processing the input data in accordance with stored computer-executable instructions, and generating output data. The processor(s) 168 may be configured to execute the computer-executable instructions to cause various operations to be performed. The processor(s) 168 may include any type of suitable processing unit including, but not limited to, a central processing unit, a microprocessor, a Reduced Instruction Set Computer (RISC), a Complex Instruction Set Computer (CISC), a microcontroller, an Application Specific Integrated Circuit (ASIC), a Field-Programmable Gate Array (FPGA), a System-on-a-Chip (SoC), and so forth.

The memory 166 may store program instructions that are loadable and executable by the processor(s) 168, as well as data manipulated and/or generated by the processor(s) 168 during the execution of the program instructions. The memory 166 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 166 may include multiple different types of memory, such as static random access memory (SRAM), dynamic random access memory (DRAM), unalterable ROM, and/or writeable variants of ROM such as electrically erasable programmable read-only memory (EEPROM), flash memory, and so forth.

The memory 166 may store data, executable instructions, and/or various program modules utilized by the claims processor computer 108 such as, for example, a host module 174, one or more operating systems (“O/S”) 176, data files 178, a DBMS 180 to facilitate management of the data files 178 and/or other data stored in the memory 166 and/or data stored in one or more datastores (not shown). The DBMS 180 may be a suitable software module that facilitates access and management of one or more datastores that may store information utilized by the claims processor computer 108 in various embodiments of the disclosure.

The data files 178 may include any suitable information that is utilized by the claims processor computer 108 to process healthcare transactions such as, for example, patient profiles, patient insurance information, other information associated with a patient, information associated with a healthcare provider, and so forth. The data files 178 may further include information associated with the results of MAC rate appropriateness review with respect to various representative healthcare claim transactions received from the reimbursement analysis computer 104.

The (O/S) 176 may include one or more program modules that control the general operation of the claims processor computer 108. The O/S 176 may manage the use of hardware resources and facilitate execution by the processor(s) 168 of computer-executable instructions provided as part of various software modules such as, for example, the host module 174 and the DBMS 180. The O/S 176 may include any suitable operating system now known or which may be developed in the future including, but not limited to, a Microsoft Windows® operating system, an Apple OSX™ operating system, a Linux-based operating system, a Unix-based operating system, or a mainframe operating system.

The host module 174 may initiate, receive, process, and/or respond to requests, such requests for adjudicating healthcare transactions, from the host module 158 of the service provider computer 106. The claims processor computer 108 may also include additional program modules for performing other pre-processing or post-processing functionality.

The claims processor computer 108 may also include one or more I/O interfaces 170 that may facilitate communication between the claims processor computer 108 and one or more input/output devices such as, for example, one or more user interface devices including, but not limited to, a display, a keypad, a control panel, a touch screen display, a remote control, a microphone, etc. that may facilitate interaction between a user and the claims processor computer 108. The claims processor computer 108 may also include one or more network interfaces 172 that may facilitate communication between the claims processor computer 108 and various other components of the illustrative architecture 100 (e.g., the reimbursement analysis computer 104, the service provider computer 106, etc.) via one or more of the network(s) 110.

Those of ordinary skill in the art will appreciate that any of the components of the architecture 100 may include alternate and/or additional hardware, software or firmware components beyond those described or depicted without departing from the scope of the disclosure. More particularly, it should be appreciated that software, firmware or hardware components depicted as forming part of any of the reimbursement analysis computer 104, the healthcare provider computer 102, the service provider computer 106, and/or the claims processor 108 computer, are merely illustrative and that some components may not be present or additional components may be provided in various embodiments. While various program modules (e.g., the reimbursement analysis application 124 or the sub-modules included therein such as the claims filtering engine 126 or the claim selection engine 130) have been depicted and described with respect to various illustrative components of the architecture 100, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, firmware and/or hardware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of ordinary skill in the art will appreciate that the illustrative networked architecture 100 depicted in FIG. 1 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative architecture 100 depicted in FIG. 1, or additional functionality.

### Illustrative Processes

FIG. 2 is a process flow diagram of an illustrative method 200 for performing various filtering and selection processing on healthcare claim transaction data in order to identify one or more representative healthcare claim transactions for use in requesting or negotiating increases in reimbursement amounts in accordance with one or more embodiments of the disclosure. According to one or more embodiments of the disclosure, functionality for performing one or more of the operations of the illustrative method 200 may be supported by the reimbursement analysis computer 104, or more specifically, the reimbursement analysis application 124 or sub-modules included therein such as the claim filtering engine 126 and/or the claim selection engine 130.

At block 202, the reimbursement analysis computer 104 may receive or otherwise access healthcare claim transaction data associated with a plurality of healthcare claim transactions. The healthcare claim transaction data may be received or accessed from any suitable data source(s) including any of those previously described.

At block 204, computer-executable instructions provided as part of the claim filtering engine 126 for example may be executed to cause a first filtering operation to be performed on the healthcare transaction data to identify a first group of healthcare claim transactions associated with healthcare products reimbursed below cost. The first filtering operation may include a comparison of reimbursement amounts to acquisition costs of healthcare products (as specified in the price data) to identify those healthcare claim transactions where the reimbursement amount was less the acquisition cost, thereby resulting in a loss to the healthcare provider that dispensed the healthcare product. As previously noted, the first filtering operation may be performed responsive to input received from a user by the reimbursement analysis application 124.

At block 206, computer-executable instructions provided as part of the claim filtering engine 126 for example may be executed to cause a second filtering operation to be performed to identify a second group of healthcare claim transactions from the first group of healthcare claim transactions. The second filtering operation may be performed in accordance with one or more filtering criteria for identifying excludable healthcare transactions from the first group that resulted in a loss due to reimbursement at amounts corresponding to rates other than the MAC rate (e.g., Usual and Customary rate, contracted rate, Ingredient Cost Submitted rate, etc.). Upon identification of the excludable healthcare transactions, they may be filtered from the first group to yield the second group of filtered healthcare claim transactions. As previously noted, the second filtering operation may be performed responsive to input received from a user by the reimbursement analysis application 124. However, in other embodiments, the first and/or second filtering operations may be performed by a scheduled software process independently of the reimbursement analysis application 124 and/or user input.

At block 208, computer-executable instructions provided as part of the claim selection engine 130 for example may be executed to cause selection processing to be performed to identify a third group of candidate healthcare claim transactions from the second group based at least in part on one or more selection parameters and associated selection parameter thresholds. As previously noted, the selection parameters may include, but are not limited to, a margin loss, an average margin loss, a net loss, an average net loss, a total number of healthcare transactions associated with a particular healthcare product, and so forth. As previously noted, the selection processing of block 208 may be performed responsive to input received from a user by the reimbursement analysis application 124.

At block 210, computer-executable instructions provided as part of the claim selection engine 130 for example may be executed to select at least one representative healthcare transaction for MAC rate appropriateness review from the third group of candidate healthcare claim transactions. In various embodiments, a user may provide input via a user interface associated with the reimbursement analysis application 124 that is indicative of the healthcare claim transactions selected as representative healthcare claim transactions for communication to an appropriate claims processor for MAC rate appropriateness review.

At block 212, computer-executable instructions provided as part of the reimbursement analysis application for example may be executed to communicate information associated with the selected representative healthcare claim transactions to an appropriate claims processor system for requesting MAC rate appropriateness review and requesting an increase in the MAC reimbursement rates.

FIG. 3 is a process flow diagram of an illustrative method 300 for identifying healthcare claim transactions reimbursed at a MAC rate below cost in accordance with one or more embodiments of the disclosure. The illustrative method 300 provides a detailed description of the operations that may be performed as part of the second filtering operation. The operations of illustrative method 300 may be performed, at least in part, upon execution of computer-executable instructions provided as part of the reimbursement analysis application 124, or more specifically, the claim filtering engine 126.

At block 302, the reimbursement analysis computer 104 may receive healthcare claim transaction data associated with a plurality of healthcare claim transactions from one or more data sources. At block 304, the reimbursement analysis computer 104 may receive price data indicative of average acquisition costs associated with a variety of healthcare products including the healthcare products to which the healthcare claim transactions relate.

At block 306, the first filtering operation may be performed in which a reimbursement level for each healthcare claim transaction may be compared the acquisition cost of the associated healthcare product to identify a first group of healthcare transactions reimbursed at a loss (e.g., where the reimbursement amount was less than the acquisition cost).

Blocks 308-320 represent an iterative process that may form at least part of the second filtering operation. At block 308, a previously unselected healthcare claim transaction from the first group may be selected. A flag or other identifier associated with the healthcare claim transactions in the first group may be checked to determine whether a transaction has been previously selected as part of the second filtering operation.

At block 310, a determination may be made as to whether the selected healthcare claim transaction was reimbursed at the Usual and Customary rate. If it is determined that the healthcare claim transaction was reimbursed at the Usual and Customary rate, the healthcare claim transaction may be excluded or filtered from the first group at block 312. On the other hand, if it is determined that the selected transaction was not reimbursed at the Usual and Customary rate, the iterative process of blocks 308-320 may proceed to block 314.

At block 314, a determination may be made as to whether the selected healthcare claim transaction was reimbursed a contracted rate. If it is determined that the healthcare claim transaction was reimbursed at a contracted rate, the selected healthcare claim transaction may be excluded or filtered from the first group at block 312. On the other hand, if it is determined that the selected transaction was not reimbursed at a contracted rate, the iterative process of blocks 308-320 may proceed to block 316.

At block 316, a determination may be made as to whether the selected healthcare claim transaction was reimbursed at the Ingredient Cost Submitted rate. If it is determined that the selected healthcare claim transaction was reimbursed at the Ingredient Cost Submitted rate, the selected healthcare claim transaction may be excluded or filtered from the first group at block 312. On the other hand, if it is determined that the selected transaction was not reimbursed at the Ingredient Cost Submitted rate, the iterative process of blocks 308-320 may proceed to block 318.

If the iterative process has reached block 318, it may be assumed that the selected healthcare claim transaction was reimbursed at a loss due to a reimbursement amount corresponding to a MAC rate that is less than the acquisition cost. Accordingly, the selected healthcare claim transaction may be identified as a member of the second group of filtered healthcare claim transactions discussed previously.

From block 318, the method 300 may proceed to block 320 where a determination may be made as to whether any unselected transactions remain from the first group. If a determination is made that no previously unselected transactions remain (e.g., the iterative process of blocks 308-320 has been performed on all transactions in the first group), the method 300 may end with a second group of filtered healthcare transactions having been identified from the first group. On the other hand, if previously unselected healthcare claim transactions remain, the iterative process may again proceed to block 308 for selection of a previously unselected healthcare claim transaction from the first group. The iterative process may continue until it has been performed for all transactions in the first group.

FIG. 3 depicts an illustrative method 300 that depicts operations performed as part of the first filtering operation as well as operations (e.g., the iterative process of blocks 308-320) performed as part of the second filtering operation. Upon completion of the second filtering function, a second group of healthcare claim transactions may be identified including transactions that were reimbursed at MAC rate that was less than the acquisition cost of the associated healthcare product. While illustrative reimbursement levels other than the MAC rate have been depicted and described, it should be appreciated that determinations with which to additional or alternative reimbursement levels may be performed as well. Further, the determinations of blocks 310, 314 and 316 may be performed in any suitable order.

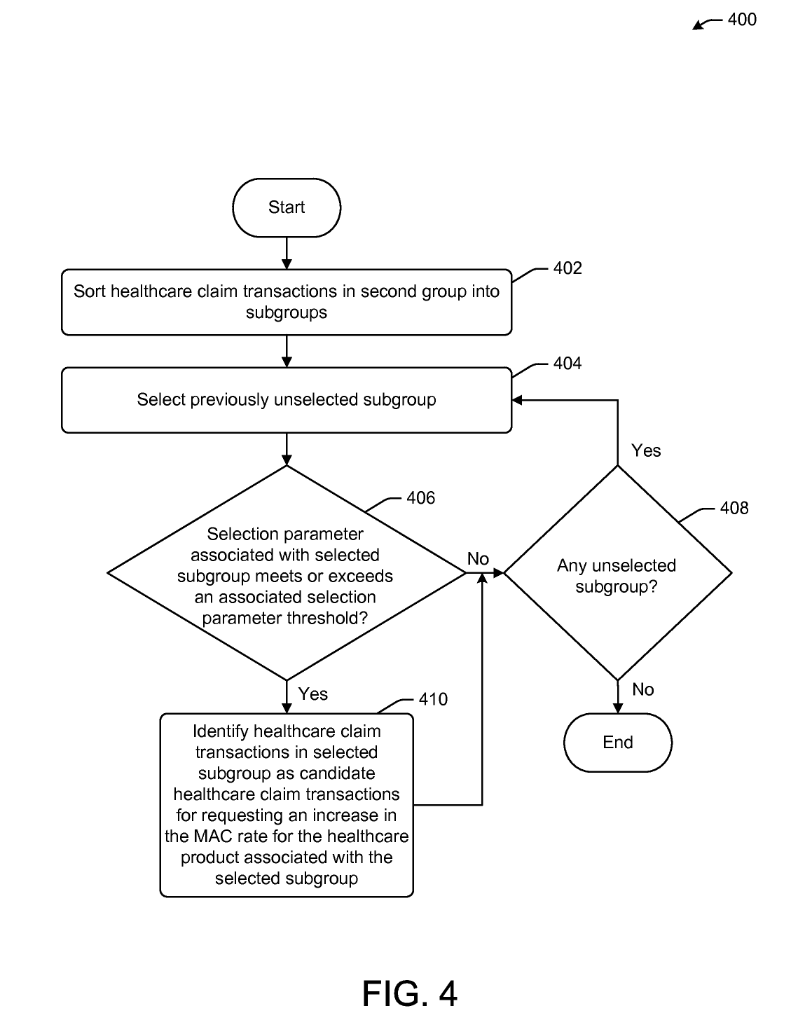

FIG. 4 is a process flow diagram of an illustrative method 400 for identifying subgroups of healthcare transactions reimbursed at a MAC rate below cost that are candidates for use in requesting or negotiating increases in reimbursement amounts in accordance with one or more embodiments of the disclosure. The subgroups may be identified from the second group of filtered healthcare claim transactions. One or more operations of the illustrative method 400 may be performed, at least in part, upon execution of computer-executable instructions provided as part of the reimbursement analysis application 124, or more specifically, the claim selection engine 130, and may be performed, at least in part, responsive to user input.

At block 402, healthcare claim transactions included in the second group of filtered healthcare claim transaction may be sorted into subgroups. The subgroups may correspond to the healthcare products associated with the transactions. For example, each subgroup may include those transactions associated with a particular healthcare product. In certain embodiments, the transactions in the second group may first be sorted or filtered according to the claims processor (e.g., PBM). For example, responsive to user input, the transactions in the second group may be further filtered to display to the user only those transactions associated with a selected claims processor.

Blocks 404-410 may form at least part of an iterative selection process for identifying healthcare claim transactions that are suitable candidates for use in requesting MAC rate appropriateness review and increases in MAC rates. While the iterative selection process of bocks 404-410 is depicted as being performed in the aggregate on subgroups of filtered healthcare claim transactions, it should be appreciated that in certain embodiments, the selection processing may be performed on individual healthcare claim transactions on a per-claim basis.

At block 404, a subgroup previously unselected during the iterative selection process may be identified. A selection parameter and associated selection parameter threshold for the subgroup may further be identified.

At block 406, a determination may be made as to whether the selection parameter associated with the selected subgroup meets or exceeds an associated selection parameter threshold. If it is determined that the selection parameter meets or exceeds the associated threshold, the method 400 may proceed to block 410 and the healthcare claim transactions forming part of the selected subgroup may be identified as candidate healthcare claim transactions for requesting an increase in the MAC rate for the healthcare product associated with the selected subgroup.

On the other hand, if it is determined that the selection parameter does not meet or exceed the associated threshold, the healthcare claim transactions forming part of the selected subgroup are not identified as candidate healthcare claim transactions, and the method 400 may proceed to block 408 where a determination may be made as to whether any subgroups remain that have not been selected as part of the iterative selection processing. If a determination is made that no previously unselected subgroup remains, the method 400 may end. On the other hand, if a determination is made that previously unselected subgroups remain, the method 400 may proceed to block 404 and a previously unselected subgroup may be selected for iterative selection processing. The iterative selection processing of blocks 404-410 may be performed until the selection processing has been performed for each identified subgroup in the second group of filtered healthcare claim transactions. The selection processing of the illustrative method 400 may result in identification of a third group of candidate healthcare transactions that are suitable candidates for requesting MAC rate appropriateness review (e.g., an increase in the MAC rates of healthcare products).

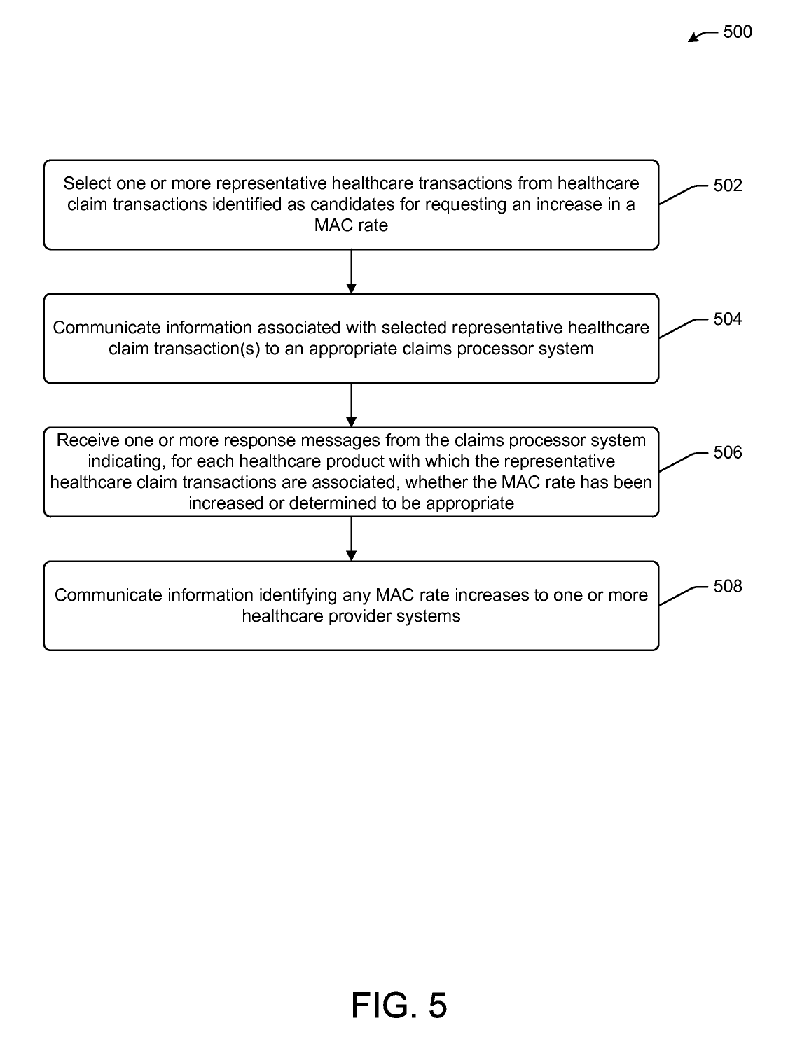

FIG. 5 is a process flow diagram of an illustrative method 500 for selecting representative healthcare transactions among candidate healthcare transactions, communicating information associated with the selected representative healthcare transactions to a claims processor, and receiving one or more response messages thereto in accordance with one or more embodiments of the disclosure. According to one or more embodiments of the disclosure, one or more operations of the method 500 may be performed, at least in part, upon execution of computer-executable instructions provided as part of the reimbursement analysis application 124, and may be performed, at least in part, responsive to user input.

At block 502, one or more representative healthcare transactions from the third group of candidate healthcare claim transactions may be selected for requesting an increase in associated MAC rate(s). The selection at block 502 may be made, in certain embodiments, responsive to user input indicative of a user selection of the representative healthcare claim transactions.

At block 504, information associated with the selected representative healthcare claim transaction(s) may be communicated from the reimbursement analysis system 104 to an appropriate claims processor system 108 for review. At block 506, one or more response messages may be received by the reimbursement analysis system 104 from the claims processor system 108 indicating, for each healthcare product for which a representative healthcare claim transaction was communicated, whether the MAC rate has been increased or determined to be appropriate. For those MAC rates that were increased, the information may identify the new increased MAC rate. At block 508, information identifying any MAC rate increases may be communicated to one or more healthcare provider systems.

The operations described and depicted in the illustrative methods 200, 300, 400 and 500 of FIGS. 2-5 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 3-5 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described for performing filtering and/or selection processing in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more function(s) or operation(s) specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method, comprising:
receiving, from one or more data sources, by a reimbursement analysis system comprising one or more computers, healthcare claim transaction data associated with a plurality of healthcare claim transactions;
performing, by the reimbursement analysis system, a first filtering operation on the healthcare claim transaction data to identify a first group of healthcare claim transactions from among the plurality of healthcare claim transactions, wherein each healthcare claim transaction in the first group of healthcare claim transactions is associated with a respective healthcare product reimbursed at a respective reimbursement level that is below a cost associated with the respective healthcare product;
performing, by the reimbursement analysis system, a second filtering operation to identify a second group of healthcare claim transactions from the first group of healthcare claim transactions;
identifying, by the reimbursement analysis system and based at least in part on one or more selection parameter thresholds, a third group of candidate healthcare claim transactions from the second group of healthcare claim transactions;
identifying, by the reimbursement analysis system, at least one healthcare claim transaction from the third group of healthcare claim transactions; and
communicating, by the reimbursement analysis system, information associated with the at least one healthcare claim transaction to a claims processor system.

2. The method of claim 1, wherein the second filtering operation comprises:
identifying, by the reimbursement analysis system and based at least in part on one or more filtering criteria, a group of excludable healthcare transactions in the first group of healthcare claim transactions; and
filtering, by the reimbursement analysis system, the group of excludable healthcare transactions from the first group of healthcare claim transactions to generate the second group of healthcare transactions.

3. The method of claim 2, wherein identifying the group of excludable healthcare transactions comprises:
determining, by the reimbursement analysis system, that each healthcare transaction in the group of excludable healthcare transactions is associated with a respective healthcare product reimbursed at a reimbursement level that corresponds to at least one of:
i) a usual and customary charge
ii) a contracted rate,
iii) an ingredient cost submitted.

4. The method of claim 1, wherein identifying a third group of candidate healthcare claim transactions comprises:
identifying, by the reimbursement analysis system, one or more subgroups of healthcare claim transactions in the second group healthcare claim transactions, where each subgroup comprises one or more healthcare transactions associated with the same respective healthcare product; and
determining that a respective selection parameter associated with each subgroup exceeds a respective selection parameter threshold of the one or more selection parameter thresholds.

5. The method of claim 4, wherein the respective selection parameter associated with each subgroup corresponds to at least one:
i) an average net loss associated with each healthcare transaction in the subgroup,
ii) an average margin loss associated with each healthcare transaction in the subgroup, or
iii) a total number of healthcare claim transactions in the subgroup.

6. The method of claim 5, wherein the each of the one or more selection parameter thresholds corresponds to at least one of:
i) a threshold percentage of the cost associated with a corresponding healthcare product,
ii) a threshold difference between the cost of the corresponding healthcare product and a reimbursement level associated with the corresponding healthcare product, or
iii) a threshold number of healthcare claim transactions.

7. The method of claim 4, wherein identifying at least one healthcare claim transaction from the third group of candidate healthcare transactions comprises identifying, from each subgroup of healthcare transactions, one healthcare transaction that is associated with a largest deviation between a cost associated with the respective healthcare product associated with the one healthcare claim transaction and the respective reimbursement level associated with the one healthcare transaction.

8. The method of claim 1, further comprising:
receiving, by the reimbursement analysis system, pricing data associated with the respective healthcare product associated with each of the plurality of healthcare claim transactions; and
identifying, by the reimbursement analysis system and based at least in part on the pricing data, the cost associated with the respective healthcare product associated with each of the at least one healthcare transaction,
wherein communicating the information associated with the at least one healthcare transaction comprises communicating i) the respective reimbursement level associated with each of the at least one healthcare transaction and ii) the cost associated with the respective healthcare product associated with each of the at least one healthcare transaction.

9. The method of claim 1, wherein each of the at least one healthcare claim transaction is associated with a different respective healthcare product.

10. The method of claim 1, wherein the plurality of healthcare transactions are adjudicated healthcare transactions, and wherein a claims processor associated with the claims processor system adjudicated each of the at least one healthcare transaction.

11. The method of claim 1, wherein the respective reimbursement level associated with each healthcare transaction in the second group of healthcare transactions is a Maximum Allowable Charge.

12. The method of claim 11, further comprising:
receiving, by the reimbursement analysis system from the claims processor system, for each of the at least one healthcare transaction, a respective indication as to whether the respective reimbursement level has been increased for the respective healthcare product.

13. The method of claim 12, further comprising:
communicating, by the reimbursement analysis system to a healthcare provider system, information indicating each respective healthcare product for which the respective reimbursement level has been increased.

14. A system, comprising:
one or more computers comprising:
at least one memory storing computer-executable instructions; and
at least one processor configured to access the at least one memory and to execute the computer-executable instructions to:
receive, from one or more data sources, healthcare claim transaction data associated with a plurality of healthcare claim transactions;
perform a first filtering operation on the healthcare claim transaction data to identify a first group of healthcare claim transactions from among the plurality of healthcare claim transactions, wherein each healthcare claim transaction in the first group of healthcare claim transactions is associated with a respective healthcare product reimbursed at a respective reimbursement level that is below a cost associated with the respective healthcare product;
perform a second filtering operation to identify a second group of healthcare claim transactions from the first group of healthcare claim transactions;
identify, based at least in part on one or more selection parameter thresholds, a third group of candidate healthcare claim transactions from the first group of healthcare claim transactions;
identify at least one healthcare claim transaction from the third group of candidate healthcare claim transactions; and
communicate or direct communication of information associated with the at least one healthcare claim transaction to a claims processor system.

15. The system of claim 14, wherein the at least one processor is configured to execute the computer-executable instructions to perform the second filtering operation by:
identifying, based at least in part on one or more filtering criteria, a group of excludable healthcare transactions from among the plurality of healthcare claim transactions; and
filtering, the group of excludable healthcare transactions from the plurality of healthcare transactions to generate the first group of healthcare transactions.

16. The system of claim 15, wherein the at least one processor is configured to identify the group of excludable healthcare transactions by:
determining that each healthcare transaction in the group of excludable healthcare transactions is associated with a respective healthcare product reimbursed at a reimbursement level that corresponds to at least one of:
i) a usual and customary charge
ii) a contracted rate,
iii) an ingredient cost submitted.

17. The system of claim 14, wherein the at least one processor is configured to execute the computer-executable instructions to identify the second group of healthcare claim transactions by:
identifying one or more subgroups of healthcare claim transactions in the second group healthcare claim transactions, where each subgroup comprises one or more healthcare transactions associated with the same respective healthcare product; and
determining that a respective selection parameter associated with each subgroup exceeds a respective selection parameter threshold of the one or more selection parameter thresholds.

18. The system of claim 17, wherein the respective selection parameter associated with each subgroup corresponds to at least one:
i) an average net loss associated with each healthcare transaction in the subgroup,
ii) an average margin loss associated with each healthcare transaction in the subgroup, or
iii) a total number of healthcare claim transactions in the subgroup.

19. The system of claim 18, wherein the each of the one or more selection parameter thresholds corresponds to at least one of:
i) a threshold percentage of the cost associated with a corresponding healthcare product,
ii) a threshold difference between the cost of the corresponding healthcare product and a reimbursement level associated with the corresponding healthcare product, or
iii) a threshold number of healthcare claim transactions.

20. The system of claim 19, wherein the at least one processor is configured to execute the computer-executable instructions to identify the at least one healthcare claim transaction from the third group of candidate healthcare transactions by:
identifying, from each subgroup of healthcare transactions, one healthcare transaction that is associated with a largest deviation between a cost associated with the respective healthcare product associated with the one healthcare claim transaction and the respective reimbursement level associated with the one healthcare transaction.

21. The system of claim 14, wherein the at least one processor is further configured to execute the computer-executable instructions to:
receive pricing data associated with the respective healthcare product associated with each of the plurality of healthcare claim transactions; and
identify, based at least in part on the pricing data, the cost associated with the respective healthcare product associated with each of the at least one healthcare transaction,
wherein the information associated with the at least one healthcare transaction communicated to the claims processor system comprises: i) the respective reimbursement level associated with each of the at least one healthcare transaction and ii) the cost associated with the respective healthcare product associated with each of the at least one healthcare transaction.

22. The system of claim 14, wherein each of the at least one healthcare claim transaction is associated with a different respective healthcare product.

23. The system of claim 14, wherein the respective reimbursement level associated with each healthcare transaction in the first group of healthcare transactions is a Maximum Allowable Charge.

24. The system of claim 14, wherein the at least one processor is further configured to execute the computer-executable instructions to:
receive, from the claims processor system, for each of the at least one healthcare transaction, a respective indication as to whether the respective reimbursement level has been increased for the respective healthcare product.

25. One or more computer-readable media storing computer-executable instructions that responsive to execution cause operations to be performed comprising:
receiving, from one or more data sources, healthcare claim transaction data associated with a plurality of healthcare claim transactions;
filtering the healthcare claim transaction data to identify a first group of healthcare claim transactions from among the plurality of healthcare claim transactions, wherein each healthcare claim transaction in the first group of healthcare claim transactions is associated with a respective healthcare product reimbursed at a respective reimbursement level that is below a cost associated with the respective healthcare product;
identifying, based at least in part on one or more selection parameter thresholds, a second group of healthcare claim transactions among the first group of healthcare claim transactions;
identifying at least one healthcare claim transaction from the second group of healthcare claim transactions; and
communicating information associated with the at least one healthcare claim transaction to a claims processor system.
